(19) United States
(12) Patent Application Publication
(10) Pub. No.: US 2026/0318803 A1
(43) Pub. Date: Oct. 15, 2026

(54) AUTOMATED MATERIAL TESTING SYSTEMS AND METHODS FOR DETERMINING SPECIFIC GRAVITY OF SAMPLE MATERIALS

(71) Applicant: The Texas A&M University System, College Station, TX (US)

(72) Inventors: Fujie Zhou, College Station, TX (US); Itan Alfredo Rivas, Buda, TX (US); Jorge Ignacio Roa, College Station, TX (US)

(73) Assignee: The Texas A&M University System, College Station, TX (US)

(21) Appl. No.: 19/647,482

(22) Filed: Apr. 14, 2026

Related U.S. Application Data
(60) Provisional application No. 63/788,608, filed on Apr. 14, 2025.

(51) Int. Cl. G01N 9/02; B25J 11/00; B25J 15/00; G01N 35/00

(52) U.S. Cl. CPC G01N 9/02; B25J 11/00; B25J 15/0033; G01N 35/00732; G01N 35/0099; G01N 2009/026

(57) ABSTRACT

An automated material testing system includes a sample scale unit including a scale configured to measure a weight of a sample container and a sample material received in the sample container, a sample conditioning unit including a reference fluid bath and a sample submersion unit including a support member configured to receive the sample container and one or more submersion actuators configured to submerge the sample container into the reference fluid bath, and a sample drying unit including an absorbent material, a platform configured to receive the sample container, and a press unit including a pair of jaws and one or more jaw actuators configured to enclose the pair of jaws around the sample container to press the absorbent material against an outer surface of the sample container.

### CROSS-REFERENCE TO RELATED APPLICATIONS

This application claims benefit of U.S. provisional patent application Serial No. 63/788,608 filed Apr. 14, 2025, and entitled "Automated Material Testing Systems and Methods for Determining Specific Gravity," which is hereby incorporated herein by reference in its entirety for all purposes.

### STATEMENT REGARDING FEDERALLY SPONSORED RESEARCH OR DEVELOPMENT

Not applicable.

### BACKGROUND

Specific gravity of materials may be tested or measured for various purposes in different industries. As but one example, specific gravity of semi-solid asphalt binder is critical to the performance of hot-mix asphalt (HMA) and/or other materials. For example, the specific gravity of asphalt binder may be used to determine the proportions of bitumen and aggregates present within the HMA. Therefore, an accurate determination of the specific gravity of the asphalt binder used in HMA and other materials may be critical to the performance of the HMA and other materials in practice.

### BRIEF SUMMARY OF THE DISCLOSURE

An embodiment of an automated material testing system for measuring the specific gravity of a sample material comprises a sample scale unit comprising a scale configured to measure a weight of a sample container and a sample material received in the sample container, a sample conditioning unit comprising a reference fluid bath at least partially filled with a reference fluid and a sample submersion unit comprising a support member configured to receive the sample container and one or more submersion actuators configured to submerge the sample container into the reference fluid bath when the sample container is received by the support member to at least partially fill the sample container with the reference fluid, and a sample drying unit comprising an absorbent material, a platform configured to receive the sample container, and a press unit comprising a pair of jaws and one or more jaw actuators configured to enclose the pair of jaws around the sample container when the sample container is positioned on the platform to press the absorbent material against an outer surface of the sample container. In some embodiments, the system comprises a robotic arm comprising a base, a gripper opposite the base, and a plurality of joints located between the base and the gripper configured to provide the gripper with a plurality of degrees of freedom. In some embodiments, the gripper comprises gripper pad having an engagement surface that defines a first receptacle configured to grip a first object and a second receptacle, separate from the first receptacle, configured to grip a second object having a different shape than the first object. In certain embodiments, the first object comprises a container body of the sample container and the second object comprises a lid of the sample container. In certain embodiments, the first receptacle extends along a first receptacle axis and the second receptacle extends along a second axis that extends at a non-zero angle relative to the first receptacle axis. In some embodiments, the system comprises a sample identification unit comprising a sensor configured to read an identifier located on the sample container. In some embodiments, the sensor comprises a camera and the identifier comprises a visually identifiable label. In certain embodiments, the pair of jaws of the sample drying unit comprises a pair of jaw pads each defining a sample receptacle configured to receive at least a portion of the sample container when the pair of jaws are in a closed position. In certain embodiments, the sample drying unit comprises a drive roller configured to drive linear motion of the absorbent material along a transport direction. In some embodiments, the sample submersion unit comprises a plurality of the support members including a lower support member and an upper support member both configured to retain the sample container to the sample submersion unit. In some embodiments, the one or more submersion actuators comprises a first submersion actuator, and wherein the sample submersion unit comprises a platform coupled between the lower support member and the first submersion actuator such that the first submersion actuator is configured to displace the lower support member along a first submersion axis. In certain embodiments, the one or more submersion actuators comprises a second submersion actuator coupled between the platform and the upper support member such that the second submersion actuator is configured to displace the upper support member along a second submersion axis relative to the lower support member.

An embodiment of a method for determining the specific gravity of a sample material comprises (a) measuring by a scale a dry weight of a sample container in a dry state containing a sample material, (b) submerging by one or more submersion actuators of a sample submersion unit the sample container positioned on a support member of the sample submersion unit into a reference fluid bath at least partially filled by a reference fluid to at least partially fill the sample container with the reference fluid such that the sample container is transitioned from a dry state to a wet state, (c) pressing by a pair of jaws of a sample drying unit the sample container positioned on a platform of the sample drying unit with an absorbent material to at least partially dry an outer surface of the sample container, (d) measuring by the scale a wet weight of the sample container in the wet state, and (e) determining the specific gravity of the sample material based on the dry weight and the wet weight of the sample container. In certain embodiments, the method comprises (f) positioning by a gripper of a robotic arm a sample container containing a sample material on a scale of a sample scale unit, (g) positioning by the gripper the sample container on the support member of a sample submersion unit, and (h) positioning by the gripper the sample container on the platform of a sample drying unit. In some embodiments, the method comprises (f) removing by a gripper of a robotic arm a lid of the sample container from a container body of the sample container. In some embodiments, the method comprises (f) linearly transporting the absorbent material along a transport direction following (c). In certain embodiments, the method comprises (f) capturing the sample container between the support member of the sample submersion unit, the support member comprising a lower support member of the sample submersion unit, and an upper support member of the sample submersion unit to lock the sample container to the sample submersion unit. In certain embodiments, the method comprises (f) coupling by a gripper of a robotic arm a lid of the sample container to a container body of the sample container with the sample container submerged in the reference fluid bath. In some embodiments, the method comprises (f) reading by a sensor an identifier located on the sample container to determine an identity of the sample container.

An embodiment of a non-transitory computer-readable medium comprising instructions, that when executed by a processor, perform the steps of measure using a scale a dry weight of a sample container in a dry state containing a sample material, submerge using one or more submersion actuators of a sample submersion unit the sample container positioned on a support member of the sample submersion unit into a reference fluid bath at least partially filled by a reference fluid to at least partially fill the sample container with the reference fluid such that the sample container is transitioned from a dry state to a wet state, press using a pair of jaws of a sample drying unit the sample container positioned on a platform of the sample drying unit with an absorbent material to at least partially dry an outer surface of the sample container, measure using the scale a wet weight of the sample container in the wet state, and determine the specific gravity of the sample material based on the dry weight and the wet weight of the sample container.

### BRIEF DESCRIPTION OF THE DRAWINGS

For a detailed description of exemplary embodiments of the disclosure, reference will now be made to the accompanying drawings in which:

FIG. 1 is a perspective view of an automated material testing system according to some embodiments;

FIG. 2 is another perspective view of the automated material testing system of FIG. 1;

FIG. 3 is another perspective view of the automated material testing system of FIG. 1;

FIG. 4 is another perspective view of the automated material testing system of FIG. 1;

FIG. 5 is a plan view of the automated material testing system of FIG. 1;

FIG. 6 is a perspective of a robotic according to some embodiments;

FIG. 7 is a side view of the robotic arm of FIG. 6;

FIG. 8 is a zoomed-in, perspective view of a gripper of the robotic arm of FIG. 6 according to some embodiments;

FIG. 9 is a top view of the gripper of FIG. 8;

FIG. 10 is a zoomed-in side view of a gripper pad of the gripper of FIG. 8 according to some embodiments;

FIG. 11 is a side cross-sectional view of a sample container according to some embodiments;

FIG. 12 is a perspective view of a specimen storage unit according to some embodiments;

FIG. 13 is a perspective view of a sample identification unit according to some embodiments;

FIG. 14 is a cross-sectional view along line 14-14 in FIG. 13 of the sample identification unit of FIG. 13;

FIG. 15 is a perspective view of a sample scale unit according to some embodiments;

FIG. 16 is another perspective view of the sample scale unit of FIG. 15;

FIG. 17 is a front view of the sample scale unit of FIG. 15;

FIG. 18 is a perspective view of a sample conditioning unit according to some embodiments;

FIG. 19 is another perspective view of the sample conditioning unit of FIG. 18;

FIG. 20 is a cross-sectional view of the sample conditioning unit along line 20-20 of FIG. 18 of the sample conditioning unit of FIG. 18;

FIG. 21 is a front view of a sample submersion unit according to some embodiments;

FIG. 22 is a perspective view of the sample submersion unit of FIG. 21;

FIG. 23 is a zoomed-in side cross-sectional view of the sample submersion unit of FIG. 21;

FIG. 24 is a perspective view of a sample conditioning unit according to some embodiments;

FIG. 25 is another perspective view of the sample conditioning unit of FIG. 24;

FIG. 26 is a top view of the sample conditioning unit of FIG. 24;

FIG. 27 is a cross-sectional view along line 27-27 in FIG. 26 of the sample conditioning unit of FIG. 24;

FIG. 28 is a perspective view of a press unit according to some embodiments;

FIG. 29 is a top view of a jaw pad according to some embodiments;

FIG. 30 is a side view of the jaw pad of FIG. 29;

FIG. 31 is a view of a gripper drying unit according to some embodiments;

FIG. 32 is a perspective view of a sample holder according to some embodiments;

FIG. 33 is a block diagram of a computer system according to some embodiments;

FIG. 34 is a zoomed-in perspective view of the automated material testing system of FIG. 1;

FIG. 35 is another zoomed-in perspective view of the automated material testing system of FIG. 1;

FIG. 36 is another zoomed-in perspective view of the automated material testing system of FIG. 1;

FIG. 37 is another zoomed-in perspective view of the automated material testing system of FIG. 1;

FIG. 38 is another zoomed-in perspective view of the automated material testing system of FIG. 1; and

FIG. 39 is a flowchart of a method for determining the specific gravity of a sample material according to some embodiments.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms "including" and "comprising" are used in an open-ended fashion, and thus should be interpreted to mean "including, but not limited to…” Also, the term "couple" or "couples" is intended to mean either an indirect or direct connection. Thus, if a first device couples to a second device, that connection may be through a direct connection, or through an indirect connection via other devices, components, and connections. In addition, as used herein, the terms "axial" and "axially" generally mean along or parallel to a central axis (e.g., central axis of a body or a port), while the terms "radial" and "radially" generally mean perpendicular to the central axis. For instance, an axial distance refers to a distance measured along or parallel to the central axis, and a radial distance means a distance measured perpendicular to the central axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, material testing systems for determining the specific gravity of constituent materials are widely employed in the characterization and quality control of composite material systems, including but not limited to HMA. In such applications, the specific gravity of semi-solid or viscous binders, such as asphalt cement or bitumen, is a critical parameter used in volumetric mix design procedures. Accurate determination of binder specific gravity enables calculation of key mix properties, including air void content, voids in mineral aggregate (VMA), and voids filled with asphalt (VFA), which collectively govern the mechanical performance, durability, and long-term stability of pavement structures. Accordingly, laboratories engaged in asphalt mix design and production quality assurance routinely employ standardized testing protocols to measure the specific gravity of asphalt binders and related materials.

Conventional material testing systems for determining specific gravity of sample materials often rely on displacement-based techniques, including pycnometer methods, water displacement approaches, or density bottle measurements. In a typical configuration, a sample material may be heated to a fluid state to facilitate handling, poured into a calibrated container of known volume, and subsequently cooled to a specified temperature. The mass of the sample-filled container is then measured and compared to the mass of the empty container and/or a reference fluid (e.g., water) to calculate specific gravity. Alternative approaches utilize vacuum-sealed pycnometers or capillary-based density measurement devices to improve accuracy by minimizing entrapped air. The weighing of the sample-filled container may be performed at a very high level of precision including, in some applications, measurements having five or more significant digits. Despite incremental improvements, such systems generally require strict adherence to procedural steps and controlled environmental conditions to ensure repeatability.

Additionally, existing material testing systems for determining specific gravity of sample materials are also characterized by a high degree of painstaking manual intervention. For instance, operators may manually weigh containers using laboratory balances, manually transfer heated binder samples using spatulas or pouring techniques, manually remove excess material, and manually ensure proper sealing of vessels. In many instances, the operator is further required to manually record measurements, perform calculations, and verify compliance with applicable standards (e.g., American Society for Testing and Materials (ASTM) or American Association of State Highway and Transportation Officials (AASHTO) procedures). This manual workflow is inherently time consuming, labor-intensive, and susceptible to human error, including inconsistencies in sample handling, drying of the exterior surface of the sample container after conditioning in the reference fluid, timing of measurements, and transcription of data.

In addition to labor demands, current testing methodologies often suffer from limited throughput and inefficiencies in workflow. Each sample typically requires individual preparation, conditioning, and measurement, resulting in relatively long cycle times per test. Furthermore, the need for repeated measurements to ensure accuracy, such as duplicate or triplicate trials, further compounds the time and labor required. These limitations can constrain laboratory productivity, particularly in high-volume testing environments such as commercial asphalt production facilities or regional materials testing laboratories.

Another limitation of conventional systems lies in their sensitivity to environmental conditions and operator technique. Variations in handling practices can affect measurement consistency, requiring skilled technicians to maintain acceptable levels of precision. This may be particularly problematic in applications demanding high degrees of precision where, for example, failing to completely dry a given sample vessel following filling with a reference fluid may introduce unacceptable amounts of error into the measurement of the specific gravity of the sample material. Additionally, the reliance on discrete measurement devices, such as separate balances, thermometers, and volumetric containers, necessitates careful coordination and calibration of multiple instruments. The absence of integrated or automated systems increases the likelihood of procedural variability and reduces the overall robustness of the testing process.

Accordingly, there exists a need for improved material testing systems capable of determining specific gravity of semi-solid materials, such as asphalt binders, in a more efficient, automated, and reproducible manner. Such systems would desirably reduce the degree of manual handling, minimize operator-dependent variability, and streamline the measurement process while maintaining or improving accuracy. Furthermore, enhanced systems may provide integrated data acquisition and analysis capabilities, thereby reducing the potential for human error and increasing throughput in laboratory and field-testing environments.

Embodiments of automated material testing systems for determining specific gravity of sample materials are disclosed herein that address at least some of the limitations of existing material testing systems outlined above. In an embodiment, an automated material testing system comprises a robotic arm for manipulating different sample containers and a computer-implemented system controller in signal communication with the robotic arm for controlling operation thereof. For instance, the robotic arm may have multiple degrees of freedom (DOFs).

In an embodiment, an automated material testing system includes a sample scale unit for measuring a weight or mass of the sample container containing a sample material, a sample conditioning unit for at least partially filling the sample container with a reference fluid, and a sample drying unit for drying an exterior of the sample container after it has been at least partially filled with the reference fluid. The gripper of the robotic arm may transport the sample container between each of these units to determine the specific gravity of the sample material based on the weights measured by the sample scale unit. Additionally, the weights may be calibrated by a known weight of the specific sample container used to carry the sample material. In this manner, the operation of each of these units and/or other equipment of the automated material testing system may be operated by a system controller in accordance with, for instance, instructions stored in a memory device thereof.

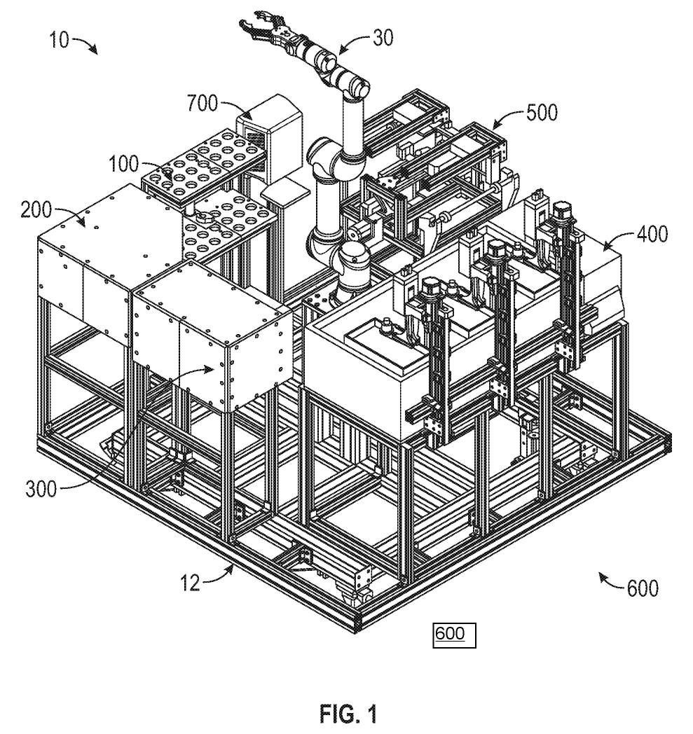

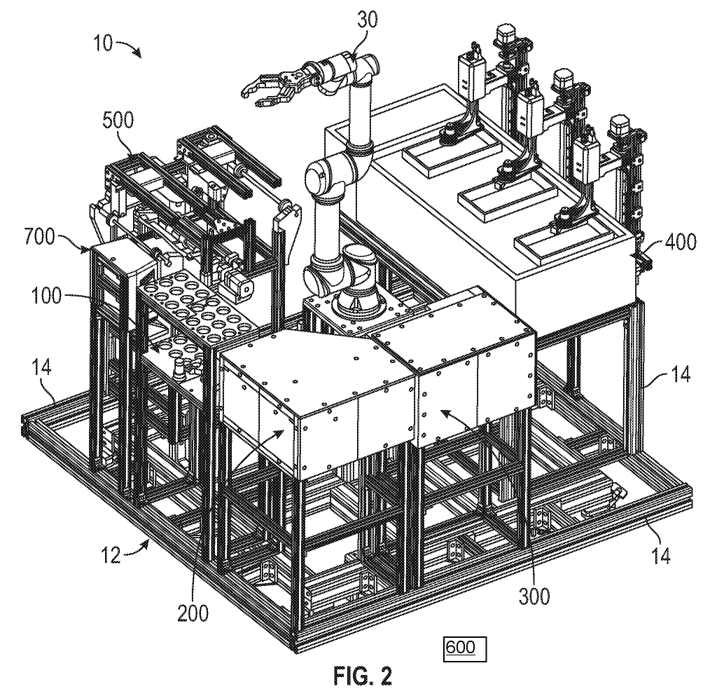

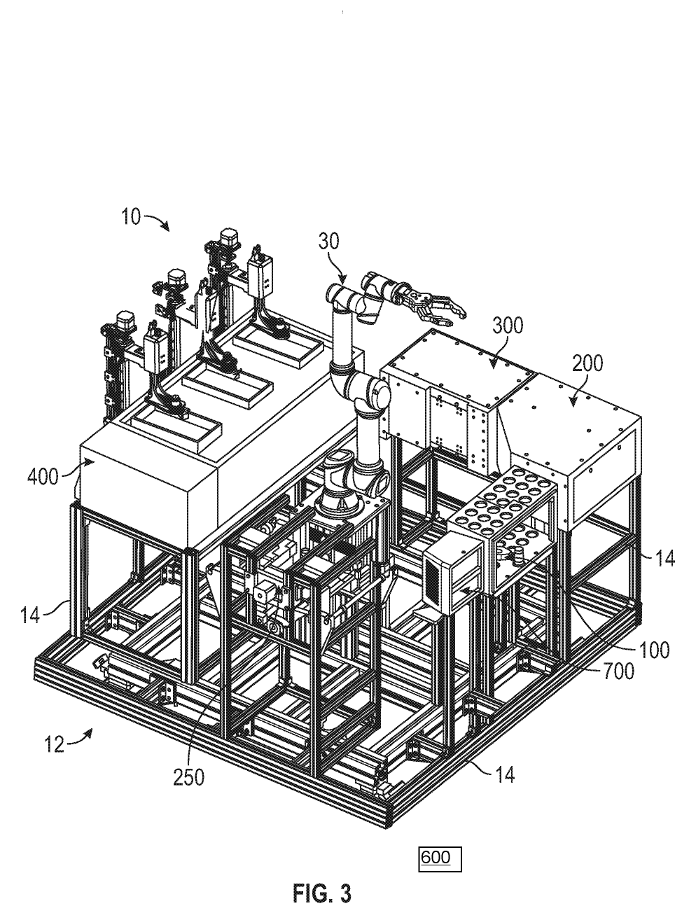

Referring to FIGS. 1-5, an embodiment of an automated material testing system 10 is shown for determining specific gravity of one or more sample materials. In this exemplary embodiment, automated material testing system 10 is configured to measure the specific gravity of semi-solid asphalt binder. However, automated material testing system 10 may measure the specific gravity of other materials including solids, semi-solids, and liquid materials that are different in nature or configuration from the exemplary semi-solid asphalt binders described herein. In this exemplary embodiment, automated material testing system 10 generally includes a support structure 12, a robotic arm 30, a specimen storage unit 100, a sample identification unit 200, a sample scale unit 300, a sample conditioning unit 400, a sample drying unit 500, and a computer-implemented system controller 600. In other embodiments, the equipment or different units forming automated material testing system 10 may vary from that shown in FIGS. 1-5. For instance, in some embodiments, automated material testing system 10 may not include each of the units or equipment shown in FIGS. 1-5 and/or may include additional units or equipment not shown in FIGS. 1-5.

As will be described further herein, the various units of automated material testing system 10 facilitate the automated determination of different sample materials without the need for manual intervention. Indeed, in some embodiments, a user of automated material testing system 10 may only be required to load sample containers containing a sample material into the automated material testing system 10. Once loaded, the automated material testing system 10 may determine the specific gravity of the sample materials contained in the loaded sample containers in a fully automated manner without the need for manual intervention or even supervision in some embodiments. Particularly, the system controller 600 of automated material testing system 10 may control the operation of the various units thereof as directed by instructions stored in one or more memory devices of the system controller 600 and which are executable by one or more processors of the system controller 600. The instructions may define one or more predefined routines to be implemented by the equipment of automated material testing system 10, including robotic arm 30, to test (e.g., determine a specific gravity of) selected material samples or specimens housed within the different sample containers.

The support structure 12 of automated material testing system 10 physically supports the various equipment and components thereof including, for example, robotic arm 30, specimen storage unit 100, sample identification unit 200, sample scale unit 300, sample conditioning unit 400, and sample drying unit 500. In some embodiments, support structure 12 may be wheeled or otherwise configured to be transportable across a floor supporting the automated material testing system 10. Additionally, support structure 12 comprises a plurality of interconnecting, elongate support members 14 (only a few of which are labeled in FIGS. 1-5); however, the configuration of support structure 12 may vary in other embodiments.

In some embodiments, support structure 12 precisely positions the different units 100, 200, 300, 400, and 500 relative to each other and relative to robotic arm 30 such that the various distances therebetween and relative positioning of these elements may be predefined and encoded into instructions stored in the system controller 600. By encoding the relative positions of robotic arm 30 and units 100, 200, 300, 400, and 500 of automated material testing system 10 into system controller 600, system controller 600 may utilize the robotic arm 30 to reliably locate and operate the various units 100, 200, 300, 400, and 500 of automated material testing system 10.

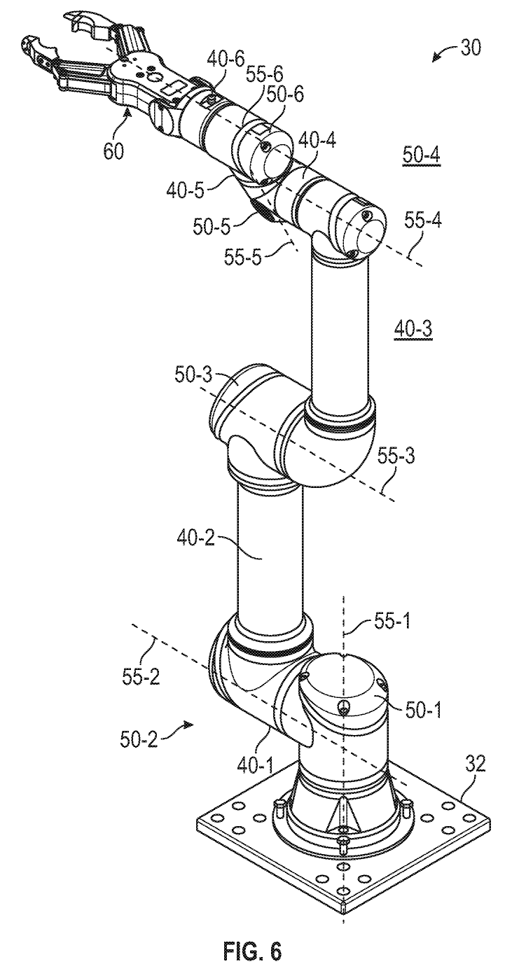

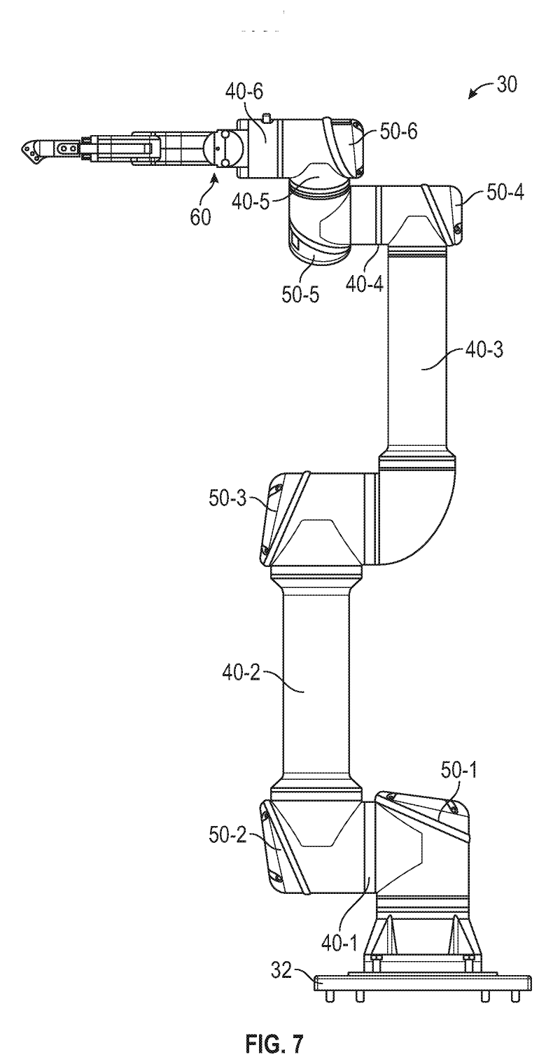

Referring to FIGS. 6 and 7, additional views of the robotic arm 30 of automated material testing system 10 are shown. In this exemplary embodiment, robotic arm 30 comprises a support base 32 located at a proximal end of the robotic arm 30, a plurality of separate elongate links or members 40 (shown as links 40-1 through 40-6 in FIGS. 6 and 7), a plurality of rotary actuators or joints 50 (shown as rotary joints 50-1 through 50-6 in FIGS. 6-8), and an end effector or gripper 60 located at a distal end of the robotic arm 30 opposite support base 32. The support base 32 is configured to attach or couple to the support structure 12 (e.g., via one or more fasteners) of automated material testing system 10 to prevent relative movement therebetween. Thus, the support base 32 and proximal end of the robotic arm 30 has a predefined, fixed position that may be encoded into instructions stored in the system controller 600.

Each rotary actuator 50 has an output rotatable about a unique rotational axis 55 (shown as rotational axes 55-1 through 55-6 in FIG. 6). For instance, gripper 60 of robotic arm 30 may be rotated relative to support base 32 about a first rotational axis 55-1 by first rotary actuator 50-1, about a second rotational axis 55-2 by second rotary actuator 50-2, and so on and so forth. Rotary actuators 50 may each comprise electric motors (e.g., servo motors) in some embodiments, while the configuration of rotary actuators 50 may vary in other embodiments. Additionally, each of rotary actuators 50 may be in signal communication with and controllable by the system controller 600 of automated material testing system 10. In some embodiments, system controller 600 may infer a pose (position and orientation) of gripper 60 in three-dimensional (3D) space based on feedback data provided by the rotary actuators 50 such as, for instance, an angular position of an output for each rotary actuator 50. In this manner, the system controller 600 may monitor and control the pose of gripper 60 during the operation of automated material testing system 10.

Rotary actuators 50, being connected between the support base 32 and gripper 60, provide gripper 60 with a plurality of DOFs relative to the support structure 12 of automated material testing system 10. In this exemplary embodiment, robotic arm 30 comprises six different rotary actuators 50 providing the gripper 60 with six separate DOFs; however, the configuration of robotic arm 30 may vary in other embodiments. For instance, in other embodiments, robotic arm 30 may comprise fewer or more than six rotary actuators 50 to provide gripper 60 with fewer or more than six separate DOFs. In still other embodiments, robotic arm 30 may include additional equipment or components not shown in FIGS. 6-8.

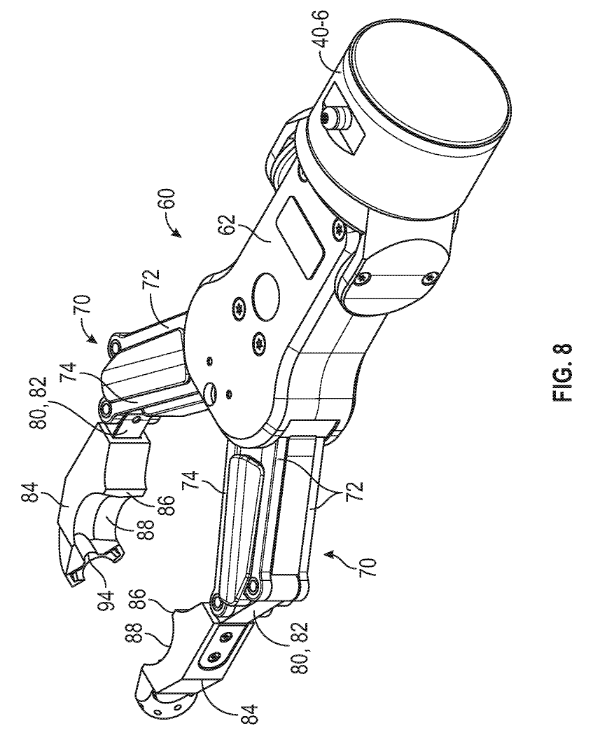

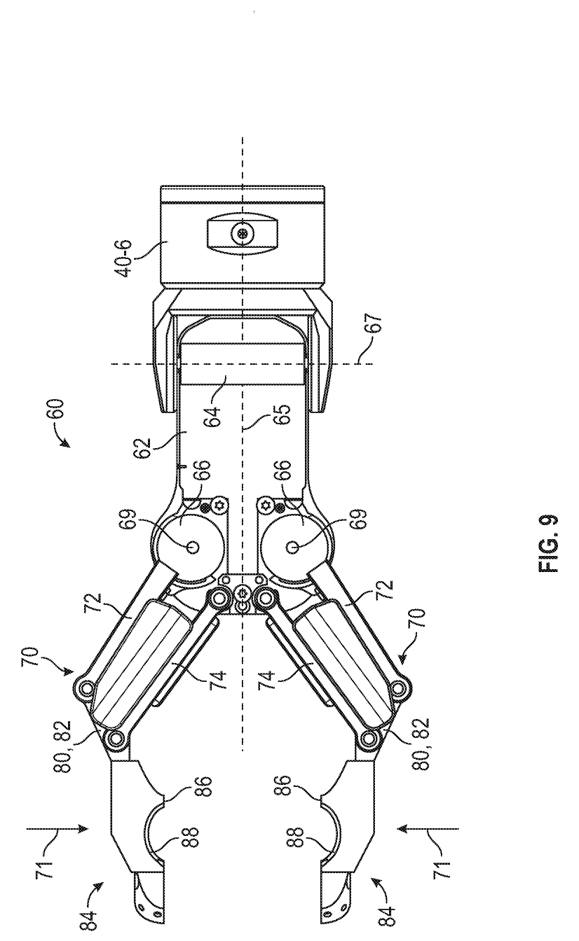

Referring to FIGS. 8 and 9, additional views of the gripper 60 of robotic arm 30 are shown. Gripper 60 extends along a longitudinal or central axis 65 and includes a carrier body 62, and a pair of jaws 70 pivotably coupled to the carrier body 62 and moveable relative to each other to grip, lift, and transport different objects. A first or proximal end of the carrier body 62 is pivotably coupled to a distal end of a final (sixth, in this example) joint 40-6 of the robotic arm 30.

A rotary carrier actuator 64 is supported by the carrier body 62 and pivotably couples the gripper 60 to the sixth joint 40-6. For instance, rotary carrier actuator 64 may be located within an interior of the carrier body 62 with a portion of the carrier body 62 hidden from view in FIG. 9 to permit illustration of carrier actuator 64. Carrier actuator 64 is operable to rotate the proximal end of carrier body 62 about a rotational axis 67 relative to the sixth joint 40-6. In this exemplary embodiment, rotational axis 67 extends orthogonal to the central axis 65 of gripper; however, the relationship between axes 65 and 67 may vary in other embodiments. Additionally, a pair of rotary jaw actuators 66 are supported by the carrier body 62 at a distal end of the carrier body 62 opposite the proximal end thereof. Jaw actuators 66 are rotatable about rotatoinal axes 69 to shift the gripper 60 between an open configuration and a closed configuration, as will be discussed further herein. Carrier actuator 64 and jaw actuators 66 may each be in signal communication with and operable by the system controller 600 of automated material testing system 10.

In this exemplary embodiment, each jaw 70 comprises a first or outer link 72, a second or inner link 74, and a finger 80 pivotably coupled to the links 72 and 74. Additionally, each finger 80 comprises a base 82 and a gripper pad 84 extending from the base 82. A first end of outer link 72 is coupled to the jaw actuator 66 while an opposing second end of outer link 72 is pivotably coupled to a terminal end of the base 82 of finger 80. Additionally, a first end of inner link 74 is pivotably coupled to the distal end of carrier body 62 and a longitudinally opposed second end of the inner link 74 is pivotably coupled to the base 82 at a position located between the terminal end thereof and the gripper pad 84. In this configuration, operation of jaw actuator 66 about its rotational axis 69 results in the lateral displacement of finger 80 in a linear direction (indicated by arrows 71 in FIG. 9) extending orthogonal to the central axis 65. In this exemplary embodiment, gripper 60 shifts between its open and closed configurations by displacing the fingers 80 of jaws 70 laterally relative to each other to grasp objects therebetween.

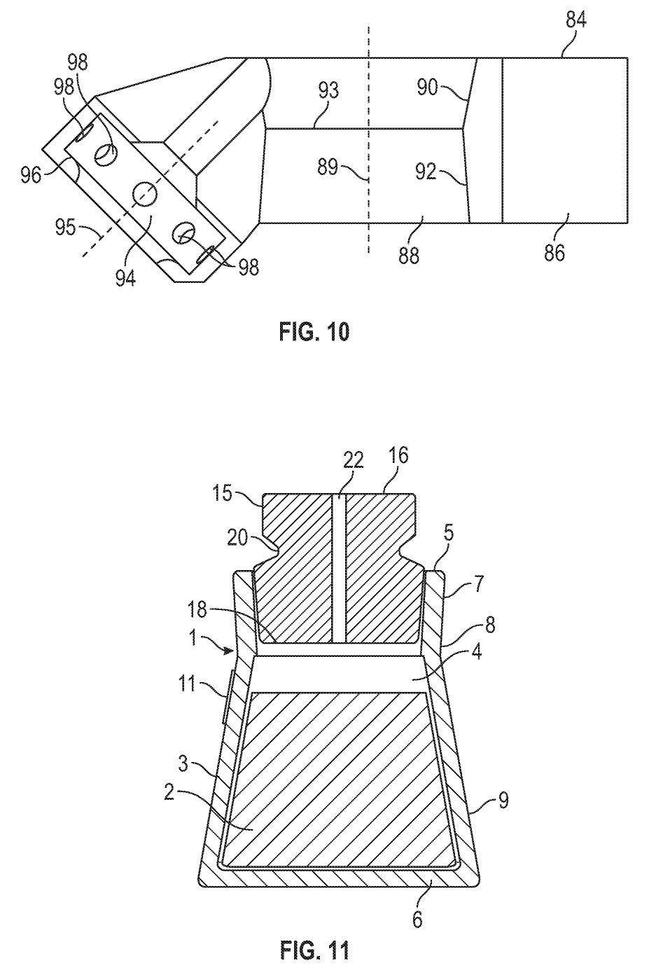

The gripper pads 84 define the terminal ends of jaws 70 and are configured to directly contact and grasp objects located between the pair of jaws 70 when the gripper 60 is in the closed configuration. In some embodiments, gripper pads 84 comprise a relatively soft material having a relatively great coefficient of friction such as elastomeric materials and the like. As shown particularly in FIG. 10, each gripper pad 84 defines a gripper surface 86 along which both a first or container body receptacle 88 and a second or container lid receptacle 94 are formed. The inclusion of both container body receptacle 88 and container lid receptacle 94 configures gripper pad 84 to grip differently shaped objects. For instance, in some embodiments, container body receptacle 88 may partially receive and grip a body of a container while the container lid receptacle 94 may partially receive and grip a lid of the container. In some embodiments, the container body receptacles 88 of jaws 70 may cumulatively define a larger central opening (e.g., having a greater minimum inner diameter) therebetween when gripper 60 is in a closed configuration than the pari of container lid receptacles 94 permitting the container body receptacles 88 to grip and carry relatively larger objects than the pair of container lid receptacles 94. However, in other embodiments, gripper pads 84 may include only a single receptacle such as, for example, the container body receptacle 88.

In this exemplary embodiment, container body receptacle 88 extends along a longitudinal or central axis 89 and is defined by a first frustoconical surface 90 extending from a first or upper end of the gripper pad 84 and a second frustoconical surface 92 extending from an opposing second or lower end of gripper pad 84. First frustoconical surface 90 meets the second frustoconical surface 92 at an annular interface 93 formed therebetween that is spaced from the upper and lower ends of gripper pad 84. Additionally, the inner diameter (ID) of container body receptacle 88 decreases moving from the upper end to the annular interface 93 and from the lower end to the annular interface 93. In this configuration, frustoconical surfaces 90 and 92 form shoulders for gripping objects such as the body of a container.

In this exemplary embodiment, container lid receptacle 94 extends along a longitudinal or central axis 95 and is defined by an annular shoulder 96 that extends orthogonal the central axis 95. Central axis 95 of container lid receptacle 94 extends at a non-zero angle (e.g., an acute angle) relative to the central axis 89 of container body receptacle 88; however, the relationship between central axes 89 and 95 may vary in other embodiments. In some embodiments, the angle formed between central axes 89 and 95 may permit the gripper pad 84 to grip a first object in a vertical orientation when the gripper pad 84 is in a first or horizontal orientation, and to grip a different, second object in a vertical orientation when the gripper pad 84 is in a second or inclined orientation. Annular shoulder 96 forms a ledge against which an object may be gripped such as a lid of a container. Additionally, in this exemplary embodiment, a plurality of circumferentially spaced openings 98 are formed in the container lid receiptacle 94. Openings 98 may facilitate the removal of excess accumulation of reference fluid (e.g., water) within the container lid receptacle 94.

As shown particularly in FIG. 11, an exemplary sample 1 container 1 is shown. As will be discussed further herein, gripper 60 of robotic arm 30 is configured to grip, lift, and carry the sample container 1. In some embodiments, sample container 1 comprises a pycnometer; however, the configuration (e.g., shape, size, materials) of sample container 1 may vary depending on the requirements of the given application such as the properties of the sample material to be tested by automated material testing system 10. In this exemplary embodiment, sample container 1 includes a body 3 defining an internal volume 4 in which a sample material or specimen (e.g., a semi-solid asphalt binder specimen) 2 is received, and a lid or stopper 15 that is partially insertable into the internal volume 4 of body 3 to enclose the internal volume 4.

The body 3 of sample container 1 extends between an upper open end 5 and a longitudinally opposed lower enclosed end or base 6. In this exemplary embodiment, body 3 defines a generally cylindrical outer surface having a first frustoconical surface 7 extending from the open end 5 and terminating at an annular interface 8, and a second frustoconical surface 9 extending from the base 6 and similarly terminating at the annular interface 8. In some embodiments, frustoconical surfaces 7 and 9 along with annular interface 8 may match the frustoconical surfaces 90 and 92 and annular interface 93 of the container body receptacle 88 of gripper pads 84 (e.g., in slope or incline angle, length, diameter) such that container body 3 may be securely received in the container body receptacles 88 of gripper pads 84 when gripper 60 is in the closed configuration whereby relative movement between gripper pads 84 and the container body 3 is restricted.

The stopper 15 of sample container 1 extends between a first or proximal end 17 and a longitudinally opposed second or distal end 17. In this exemplary embodiment, body 3 defines a generally cylindrical outer surface extending between ends 16 and 18 and having an annular groove 20 formed therealong. Additionally, the outer surface of stopper 15 may define a frustoconical surface extending from groove 20 to the lower end 18 that is slidably insertable into the open end 5 of container body 3 to form a friction fit with a mating frustoconical inner surface of the container body 3. In this exemplary embodiment, stopper 15 includes a fluid passage 22 extending between ends 16 and 18 to permit air within the internal volume 4 of container body 3 to escape in response to the insertion of the distal end 18 of stopper 15 into the open end 5 of container body 3.

In this exemplary embodiment, container body receptacles 88 of gripper pads 84 are configured to grip container body 3 while the second receptacles 94 of gripper pads 83 are instead configured to grip the stopper 15 whereby the robotic arm 30 may decouple and remove the stopper 15 from container body 3 and/or insert and couple the stopper 15 to the container body 3 as needed. Particularly, first frustoconical surface of container body 3 may rest against the annular shoulder formed by first frustoconical surface 90 of first receptacle 88 to secure the gripper pads 84 to the container body 3. Additionally, the annular shoulder 96 of second receptacle 94 may be interlockingly received in the annular groove 20 of stopper 15 to secure the gripper pads 84 to the stopper 15.

Further, in this exemplary embodiment, a label 11 is positioned on the outer surface of the container body 3 of sample container 1. Label 11 may include text and/or other markings (e.g., a bar code, a quick-response (QR) code) that are readable by a sensor whereby the system controller 600 may identify the specific sample container 1 comprising the label 11. Particularly, each sample container 1 may have a weight that slightly varies or is unique from the weights of the other sample containers 1 such that the system controller 600 may identify the specific sample container 1 containing the sample material being tested so that the specific weight of the sample container 1 may be used in determining the specific gravity of the sample material received in the specific sample container 1. While label 11 is shown as positioned on the container body 3 in FIG. 11, in other embodiments, label 11 may be located on the container body 3 and/or the stopper 15.

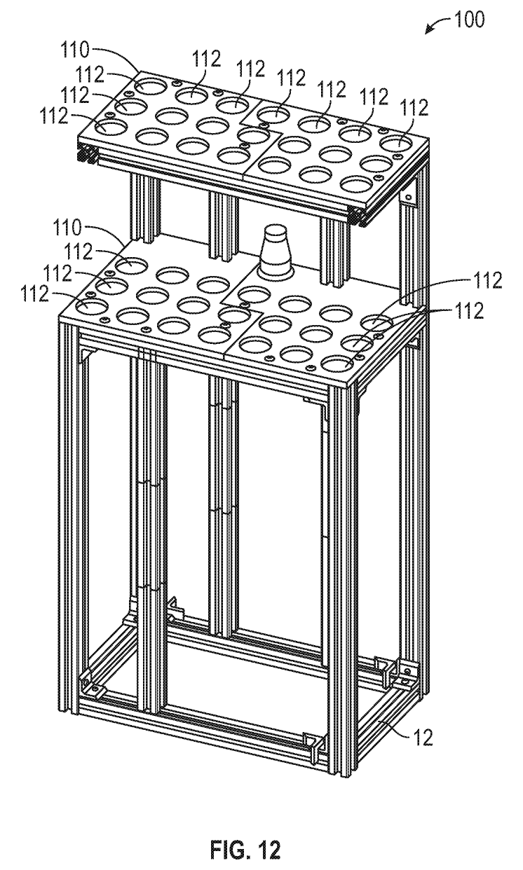

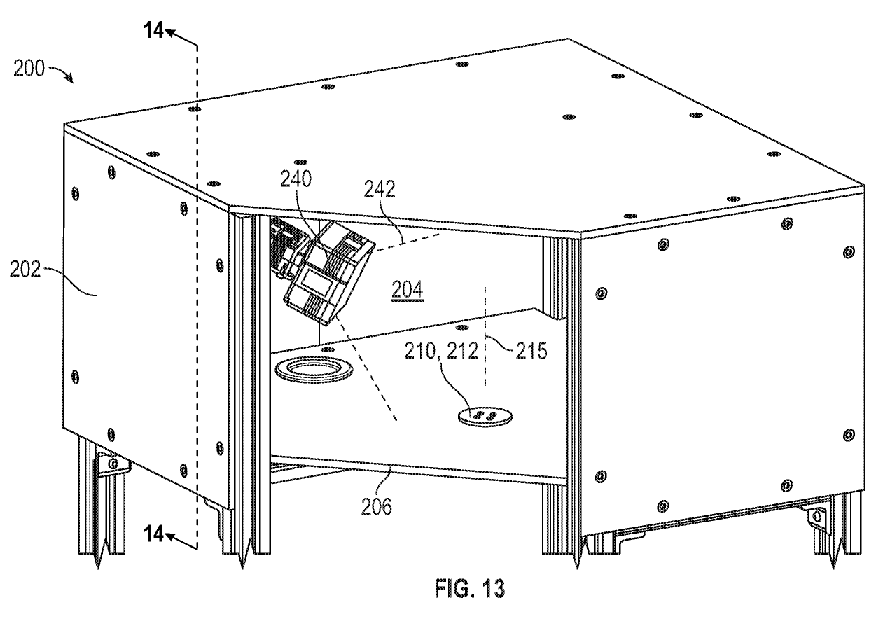

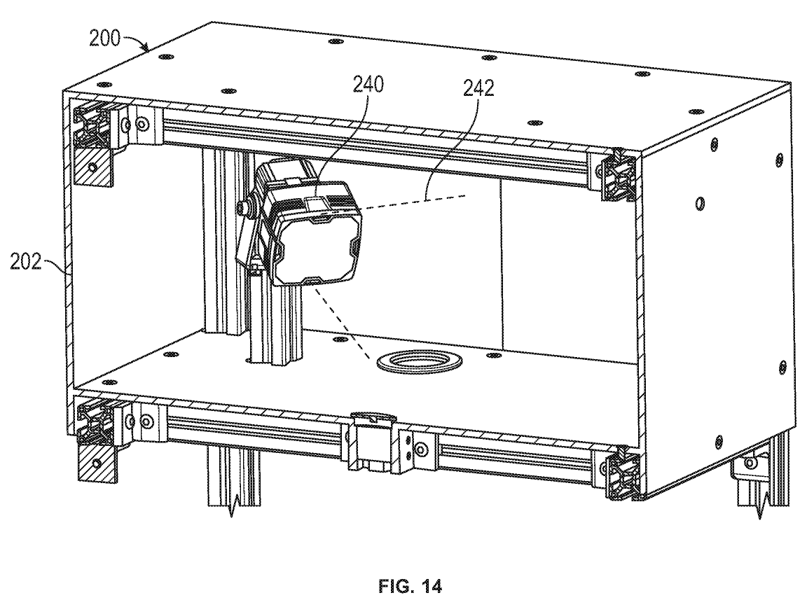

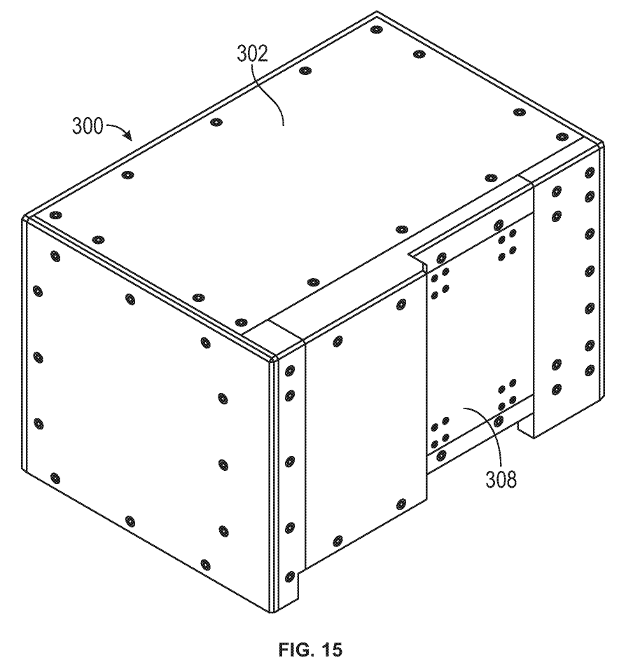

Referring to FIG. 12, an additional view of the specimen storage unit 100 of automated material testing system 10 is shown. Specimen storage unit 100 is configured to receive or temporarily store one or more different sample materials such as, for example, a plurality of different sample containers 1 each containing a different sample material 2 to be tested by the automated material testing system 10. In this exemplary embodiment, specimen storage unit 100 comprises one or more storage shelves 110 each physically supported by the support structure 12 of automated material testing system 10. Additionally, a plurality of regularly spaced receptacles 112 (only some of which are labeled in FIG. 12) are formed along each storage shelf 110 for receiving a plurality of sample containers such as the sample container 1 shown in FIG. 11. In other embodiments, storage shelves 110 may be separately supported by a support structure other than support structure 12.

The location of each specific receptacle 112 may be encoded in instructions stored in the system controller 600 such that the system controller 600 may be aware of the location in physical space (relative to the base 32 of robotic arm 30, for example) of each specific receptacle 112 such that the system controller 600 may instruct the gripper 60 of robotic arm 30 to pick up a given sample container 1 located in a specific receptacle 112 of the plurality of receptacles 112. In some embodiments, system controller 600 may be programmed to test the contents of a first sample container 1 located in a first receptacle 112, followed by testing the contents of a second sample container 1 located in a second receptacle 112 (e.g., located adjacent to the first receptacle 112) and so on and so forth until each sample receptacle 1 loaded onto the specimen storage unit 100 has been tested by the automated material testing system 10.

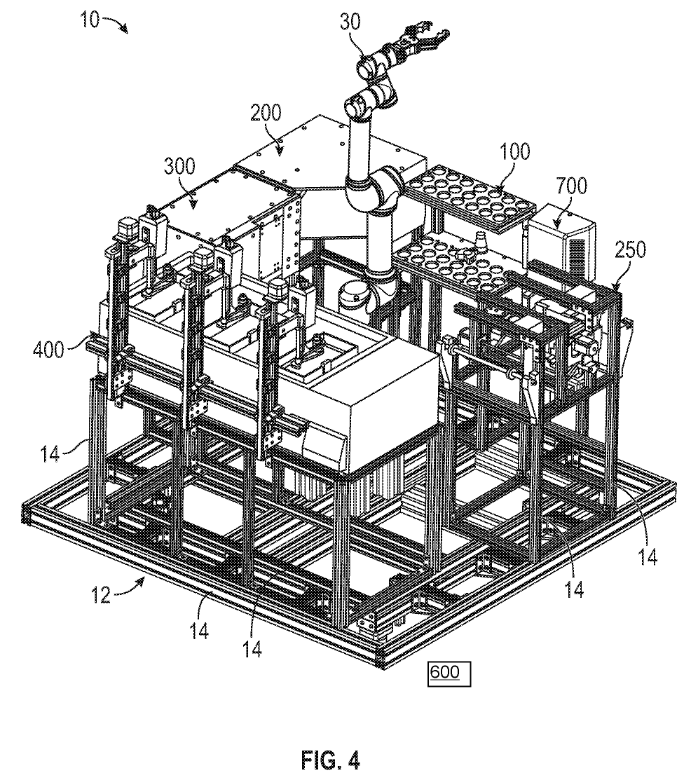

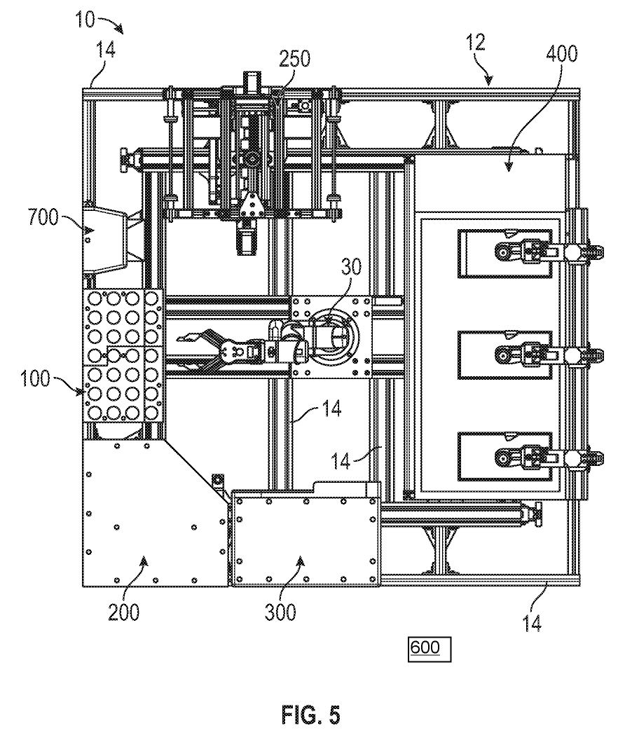

Referring to FIGS. 4 and 5, additional illustrations of the sample identification unit 200 of automated material testing system 10 are provided. Sample identification unit 200 interfaces with the robotic arm 30 to facilitate the automated identification of selected sample containers 1. In this exemplary embodiment, sample identification unit 200 includes a housing 202, a sample stage 210, and a sensor 240. In some embodiments, sample identification unit 200 is physically supported by the support structure 12 of automated material testing system 10 such that the position of sample identification unit 200 in physical space (e.g., relative to base 32 of robotic arm 30) may be encoded into instructions stored in the system controller 600. In other embodiments, sample identification unit 200 may be separately supported by a support structure other than support structure 12.

The housing 202 of sample identification unit 200 defines an interior 204 that is accessible by the robotic arm 30 via an opening 206 of the housing 202. The sample stage 210 is located within the interior of housing 202 and is configured to receive sample containers 1 which may be positioned atop the sample stage 210 within the interior 204 of housing 202. In this exemplary embodiment, an electric motor or rotary actuator 212 is coupled to the sample stage 210 for rotating the sample stage 210 about a vertically extending rotational axis 215. In other embodiments, sample identification unit 200 may not include either sample stage 210 or rotary actuator 212 and instead the sample containers 1 may be positioned along a surface of the housing 202. Rotation of the sample container 1 about rotational axis 215 permits the entire circumference of the sample container 1 to pass across a field of view 242 of the sensor 240 which is also positioned in the interior of housing 202 with the field of view 242 thereof oriented in the direction of the sample stage 210. By rotating sample container 1 about rotational axis 215, the label 11 of sample container 1 may be read by the sensor 240 irrespective of the angular position of the sample container 1 when it is initially positioned on the sample stage 210 by the gripper 60 of robotic arm 30. Thus, sample container 1 may be identified by the sample identification unit 200 without the sample container 1 needing to be loaded into sample identification unit 200 in a predefined angular position.

In some embodiments, sensor 240 comprises an image sensor or camera configured to read identification data contained in the label 11 positioned on the sample container 1. Both the rotary actuator 212 and the sensor 240 is in signal communication with and operable by the system controller 600 of automated material testing system 10 such that the system controller 600 may match the identification of the sample container 1 read off the label 11 thereof by sample identification unit 200 with specifications or parameters of the sample container 1 matching the identification and stored in the system controller 600 such as, for example, the precise (empty) weight of the sample container 1 matching the identification. In certain embodiments, sensor 240 may read separate identity data located on the body 3 and stopper 15 of the sample container 1 to ensure the identified body 3 and stopper 15 match. In some embodiments, system controller 600 may comprise an artificial intelligence (AI) and/or computer vision algorithm to read the identity data from the label 11 positioned on the sample container 1

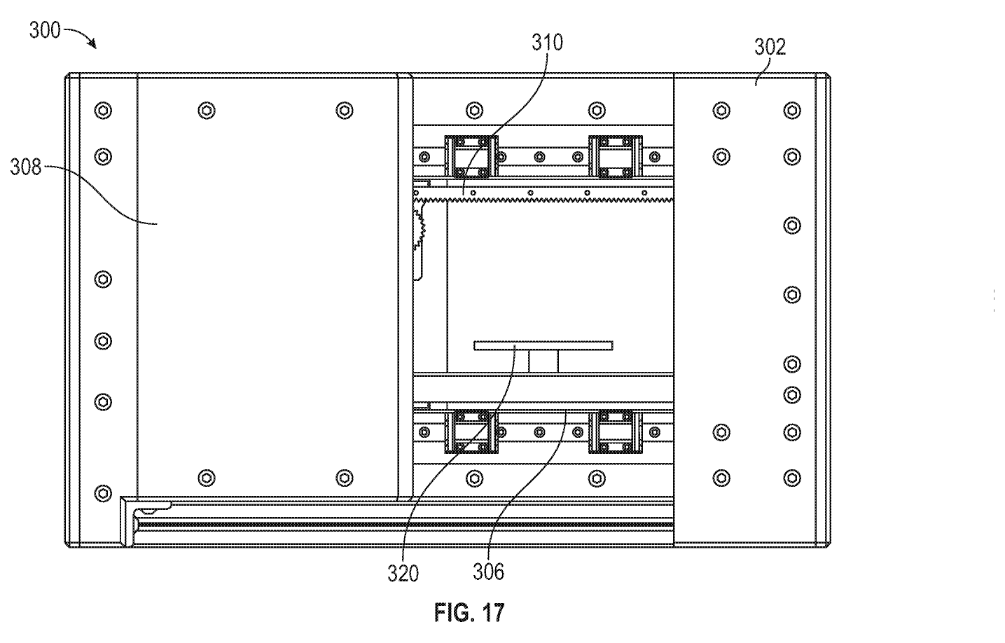

Referring to FIGS. 15-17, additional illustrations of the sample scale unit 300 of automated material testing system 10 are provided. Sample scale unit 300 interfaces with robotic arm 30 to facilitate the automated determination of the mass of a selected sample container 1. Particularly, the sample scale unit 300 may measure the mass of the sample container 1 when partially filled with only the sample material 4 and/or when filled by both the sample material 4 and an additional volume of a reference fluid (e.g., water) that is added to the sample container 1 in addition to sample material 4, as will be described further herein. In some embodiments, sample scale unit 300 is physically supported by the support structure 12 of automated material testing system 10 such that the position of sample scale unit 300 in physical space (e.g., relative to base 32 of robotic arm 30) may be encoded into instructions stored in the system controller 600. In other embodiments, sample scale unit 300 may be separately supported by a support structure other than support structure 12.

In this exemplary embodiment, sample scale unit 300 generally comprises a housing 302 and a scale 320 positioned within an interior 304 of the housing 302 and upon which a selected sample container 1 may be placed by the gripper 60 of robotic arm 30. The interior 304 of housing 302 is accessible by an opening 306 that, in this exemplary embodiment, is enclosable by a member or door 308 of the sample scale unit 300 that is transportable between an open position (exposing the opening 306 of housing 302) and a closed position (closing the opening 306) by a linear actuator (e.g., driven by an electric motor) 310 of the sample scale unit 300 that is coupled between the housing 302 and door 308. The linear actuator 310 may be in signal communication with and operable by the system controller 600 of automated material testing system 10. By enclosing the opening 306 of housing 302, the accuracy of the weight measurement of the sample container 1 may be maximized by preventing drafts of air from entering the interior 304 of the housing 302 which could otherwise disturb the weighing of the sample container 1 by the scale 320 and decrease the accuracy of the resulting weight measurement.

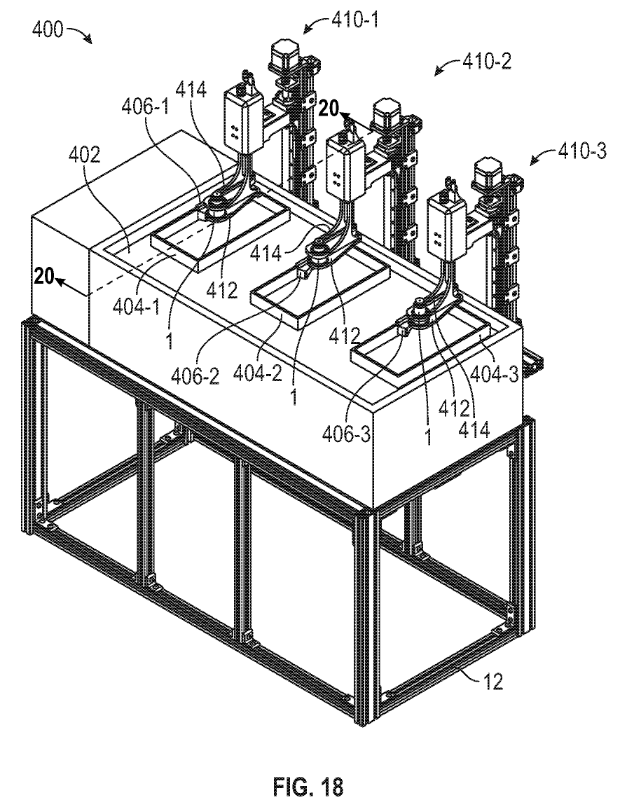

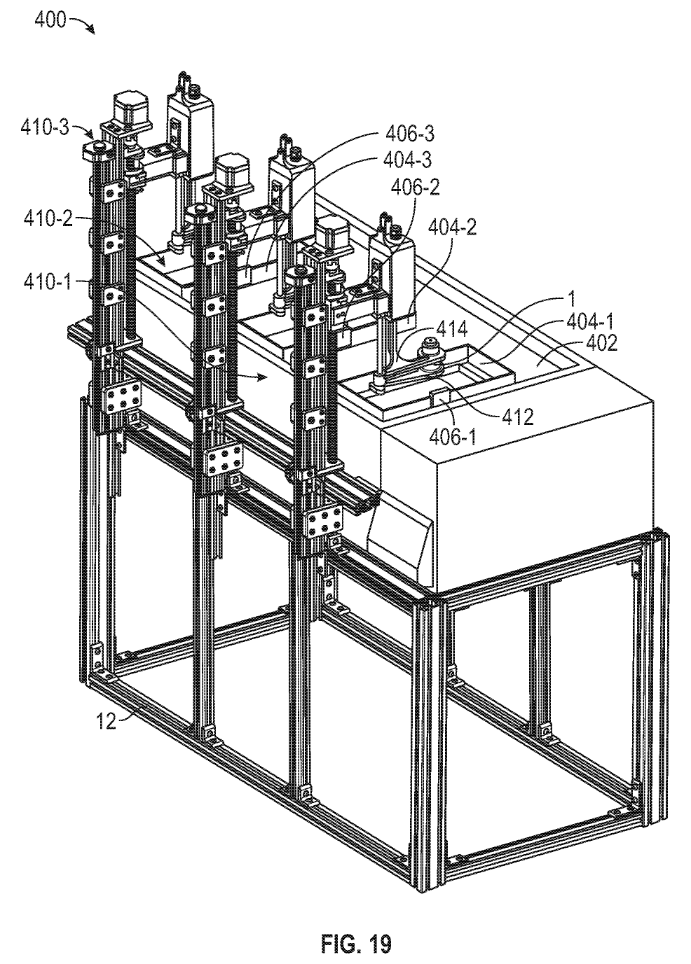

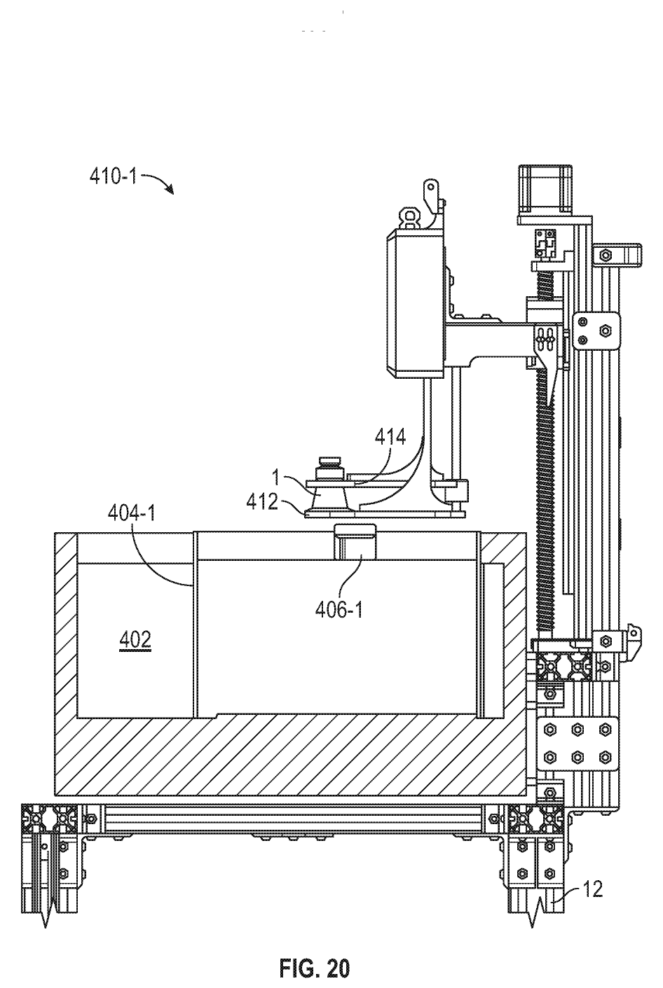

Referring to FIGS. 18-20, additional illustrations of the sample conditioning unit 400 of automated material testing system 10 are provided. Sample conditioning unit 400 is configured to fill (e.g., entirely or substantially entirely) sample containers 1 with a reference fluid (e.g., water in this exemplary embodiment) stored in a reference fluid vessel or 402 of the sample conditioning unit 400. In certain embodiments, sample conditioning unit 400 is physically supported by the support structure 12 of automated material testing system 10 such that the position of sample conditioning unit 400 in physical space (e.g., relative to base 32 of robotic arm 30) may be encoded into instructions stored in the system controller 600. In other embodiments, sample conditioning unit 400 may be separately supported by a support structure other than support structure 12.

In addition to reference fluid vessel 402, sample conditioning unit comprises one or more sample submersion units 410 (shown as sample submersion units 410-1 through 410-3 in FIGS. 18-20). Although sample conditioning unit 400 is shown in FIGS. 18-20 as including three sample submersion units 410, in other embodiments, sample conditioning unit 400 may include fewer than three sample submersion units 410 (e.g., a single sample submersion unit 410) or more than three sample submersion units 410. In this exemplary embodiment, reference fluid vessel 402 is divided into one or more self-contained reference fluid baths 404 (shown as reference fluid baths 404-1 through 404-3 in FIGS. 18-20).

Each reference fluid bath 404 is at least partially filled with the reference fluid and is segregated from the reference fluid contained in the other reference fluid baths 404 and the reference fluid contained in the surrounding reference fluid vessel 402. In this manner, turbulence or wave action occurring in a first reference fluid bath 404-1 as a result of the submersion of a sample container 1 therein does not disturb the reference fluid contained in the other reference fluid baths 404-1 and 404-2 which could otherwise interfere with the operation of their corresponding sample submersion units 410-2 and 410-3. However, in other embodiments, sample conditioning unit 400 may only include reference fluid vessel 402 and not the individual reference fluid baths 404 each associated with a specific sample submersion unit 410.

Additionally, each reference fluid bath 404 includes a temperature sensor 406 (shown as temperature sensors 406-1 through 406-3 in FIGS. 18-20) for monitoring the temperature of the reference fluid contained therein. In this manner, it may be determined that a submerged sample material 2 submerged therein has achieved a predefined, setpoint temperature via heat transfer from the reference fluid (e.g., water) contained in the reference fluid bath 404 and the sample material 2. In some embodiments, the sample container 1 may be submerged in the reference fluid bath 404 for a predefined period of time to ensure the temperature of the reference fluid contained in the reference fluid bath 404 has had an opportunity to equalize with the temperature of the sample material 2 contained in the sample container 1.

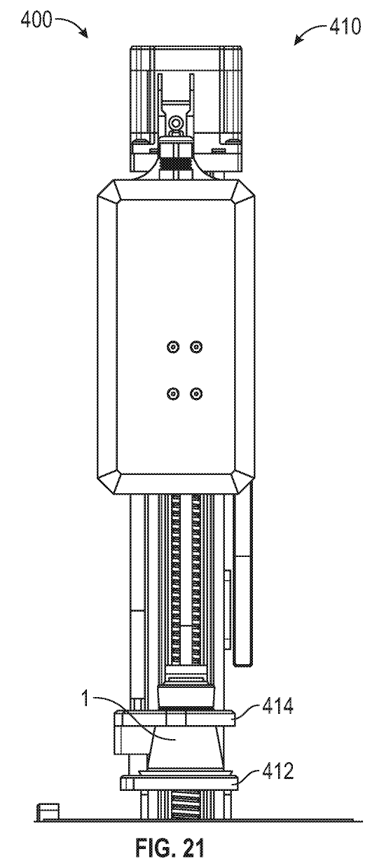

Referring to FIGS. 21-23, additional views of one of the sample submersion units 410 of sample conditioning unit 400 is shown. Sample submersion units 410 are configured to selectably submerge sample containers 1 into the reference fluid (e.g., water) contained in reference fluid baths 404. In this exemplary embodiment, each sample submersion unit 410 generally includes a mount 412 for coupling the sample submersion unit 410 to the reference fluid vessel 402, a linear, first submersion actuator 420, a linearly transportable platform 430, an L-shaped first or lower support arm or member 440, a linear, second submersion actuator 450, and an L-shaped second or upper support arm or member 460. Mount 412 extends longitudinally between a first or proximal end 414 and an opposing second or distal end 416. Mount 412 mounts or couples to the reference fluid vessel 402 at the proximal end 414 thereof with the distal end 416 positioned vertically above the reference fluid vessel 402.

The first submersion actuator 420 couples to the mount 412 at the distal end 416 thereof. First submersion actuator 420 may be driven by an electric motor and may comprise a lead screw or similar mechanisms for facilitating rectilinear movement along a vertically extending transport axis 425. Particularly, a proximal end 432 of platform 430 is coupled to the first submersion actuator 420 with platform 430 being vertically transportable rectilinearly in either direction along the transport axis 425 in response to the operation of first submersion actuator 420. Platform 430 extends longitudinally between the proximal end 432 coupled to first submersion actuator 420 and an opposing distal end 434 coupled to the second submersion actuator 450. The actuators 420 and 450 are in signal communication with and operable by the system controller 600 as will be discussed further herein.

The lower support arm 440 couples to and is suspended from the platform 430 such that the lower support arm 440 is vertically transportable along transport axis 425 in concert with the platform 430. In this exemplary embodiment, lower support arm 440 includes a vertical member 442 and a lower horizontal member 444 coupled to and extending from the vertical member 442 at an angle (e.g., orthogonally). Particularly, vertical member 442 extends between a first or proximal end coupled to the platform 430 and a longitudinally opposed second or distal end coupled to the lower horizontal member 444. Similarly, lower horizonal member 444 extends between a first or proximal end coupled to the distal end of vertical member 442 and a longitudinally opposed second or distal end.

Second submersion actuator 450 is coupled to the distal end 434 of platform 430 and may be driven by an electric motor and may comprise a lead screw or similar mechanisms for facilitating rectilinear movement along a vertically extending locking axis 455 that is horizontally spaced from the transport axis 425. Upper support arm 460 couples to and is suspended from the second submersion actuator 450 such that the upper support arm 460 is vertically transportable along locking axis 455 independent of the platform 430 and mount 412.

In this exemplary embodiment, upper support arm 460 includes a vertical member 462 and an upper horizontal member 464 coupled to and extending from the vertical member 462 at an angle (e.g., orthogonally). Particularly, vertical member 462 extends between a first or proximal end coupled to the second submersion actuator 450 and a longitudinally opposed second or distal end coupled to the upper horizontal member 464. Similarly, upper horizonal member 464 extends between a first or proximal end coupled to the distal end of vertical member 462 and a longitudinally opposed second or distal end.

A lower support pad 446 is positioned along the lower horizontal member 444 at or proximal to the distal end thereof for supporting a sample container 1 positioned atop the lower support pad 446. Additionally, an upper support pad 466 is positioned along the upper horizontal member 464 at or proximal to the distal end thereof for restricting or at least minimizing or delimiting relative movement between the sample container 1 positioned atop the lower support pad 446 and the lower support pad 446 such that the upper support pad 466 locks the sample container 1 to the lower support pad 446.

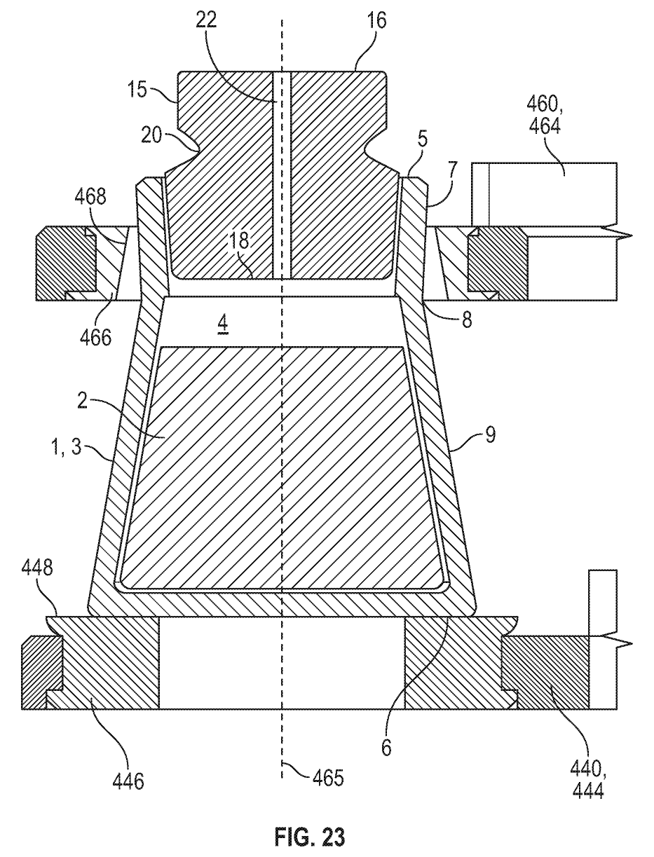

In some embodiments, support pads 446 and 466 of horizontal members 444 and 464, respectively, comprise a relatively soft material having a relatively great coefficient of friction such as elastomeric materials and the like. Support pads 446 and 466 are each aligned along a support axis 465. As shown particularly in FIG. 23, lower support pad 446 is generally annular in this exemplary embodiment, defining a planar support surface 448. The central opening formed in support pad 446 may prevent the trapping of air between the lower end 6 of the container body 3 and support pad 446. In other embodiments, lower support pad 446 may not be annular in shape and instead may not include a central passage or opening. Additionally, in this exemplary embodiment, upper support pad 466 is also annular in shape having a central passage defined by a frustoconical inner support surface 468.

Upper support arm 460 is shown occupying a lower or closed position in FIG. 23 in which a lower end of the upper support pad 466 and an upper end of the lower support pad 446 are separated by a first distance that is less than the length of the body 3 of sample container 1 extending between ends 5 and 7. With upper support arm 460 in the lower position, interference between the inner support surface 468 of upper support pad 466 and the surface 9 of the container body 3 restricts or delimits relative movement between the container body 3 and the lower support pad 446 such that the sample container 1 cannot be inadvertently dropped from sample submersion unit 410 when being carried thereby.

Additionally, upper support arm 460 is transportable by the second submersion actuator 450 from the lower position to an upper or open position that is vertically spaced from the lower position along the support axis 465. Particularly, when upper support arm 460 occupies the upper position, the lower end of the upper support pad 466 and the upper end of the lower support pad 446 are separated by a second distance that is greater than both the first distance and the length of the body 3 of sample container 1 extending between ends 5 and 7. Thus, with upper support arm 460 in the upper position, the container body 3 of a sample container may be positioned by the gripper 60 of robotic arm 30 between the support arms 440 and 460 along support axis 465 and lowered upon the lower support surface 448 of lower support pad 446. Once the container body 3 sits atop the lower support surface 448, the upper support arm 460 may be lowered along support axis 465 from the upper position to the lower position to lock the container body 3 to the sample submersion unit 410.

Referring generally to FIGS. 18-23, as will be discussed further herein, by locking the container body 3 to the sample submersion unit 410, the container body 3 may be vertically lowered in concert with the platform 430 by operation of the first submersion actuator 420 to completely submerge the container body 3 in the reference fluid (e.g., water) contained in the reference fluid bath 404. Moreover, the rate at which container body 3 is submerged into the reference fluid bath 404 may, in some embodiments, be precisely controlled (e.g., at a low rate of speed) by operation of the first submersion actuator 420 to ensure any air present within the internal volume 4 of container body 3 has an opportunity to escape therefrom and thus will not remain trapped within the internal volume 4. In addition, the open end 5 of container body 3 is accessible with upper support arm 460 in the closed position such that the stopper 15 may be attached to the container body 3 with the container body 3 submerged in the reference fluid bath 404 in a manner that permits any bubbles present within fluid passage 22 of stopper 15 has an opportunity to escape during submersion.

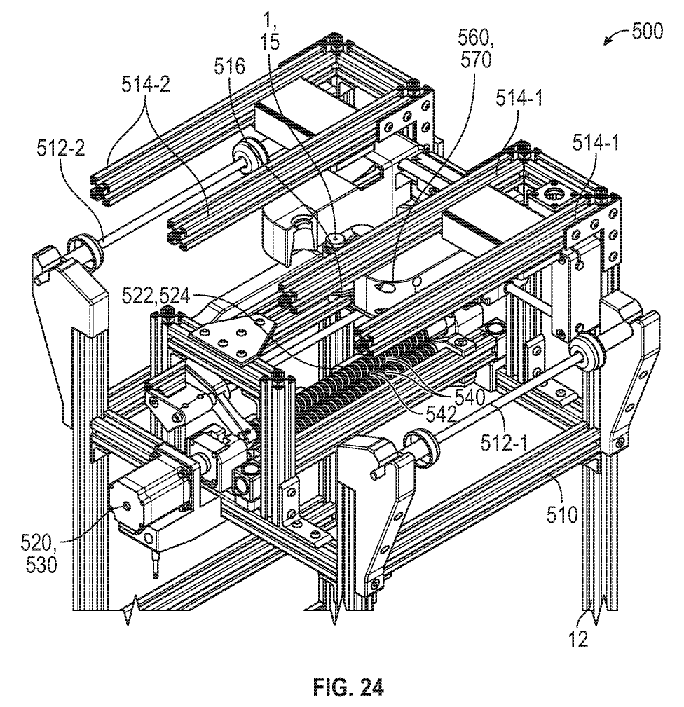

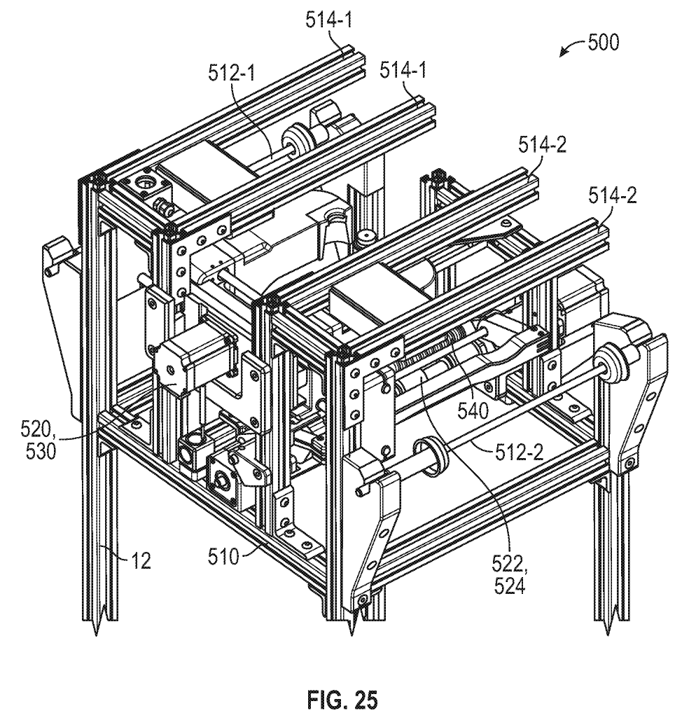

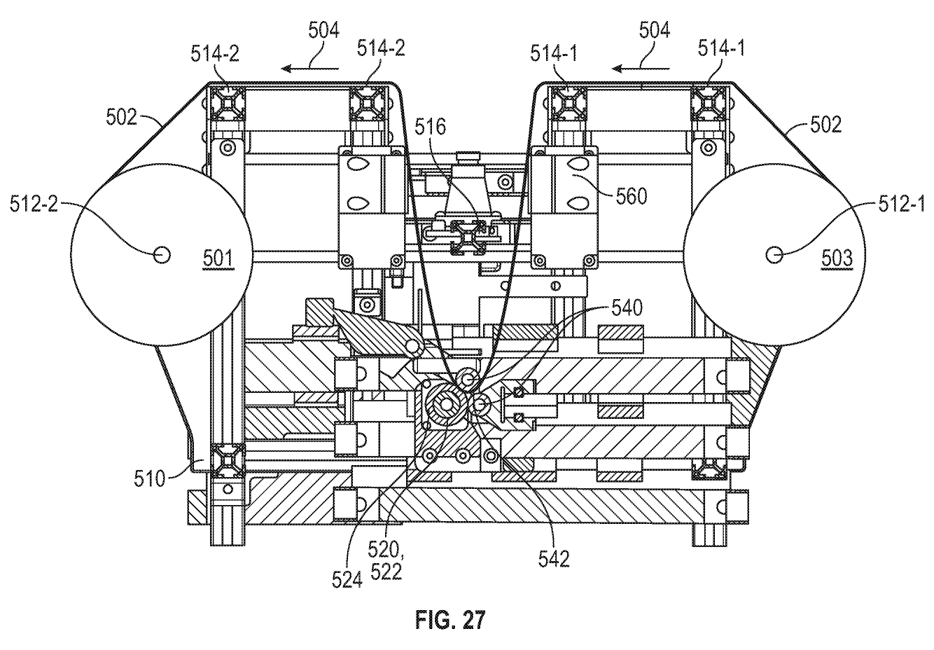

Referring to FIGS. 24-27, additional illustrations of the sample drying unit 500 of automated material testing system 10 are provided. Sample drying unit 500 dries the sample containers 1 after being filled by sample conditioning unit 400 with a reference fluid (e.g., water). Particularly, in this exemplary embodiment, sample drying unit 500 contacts an absorbent material 502 (shown in FIG. 27) with the sample container 1 to transfer moisture from external surfaces of the sample container 1 to the absorbent material 502. In certain embodiments, sample drying unit 500 is physically supported by the support structure 12 of automated material testing system 10 such that the position of sample drying unit 500 in physical space (e.g., relative to base 32 of robotic arm 30) may be encoded into instructions stored in the system controller 600. In other embodiments, sample drying unit 500 may be separately supported by a support structure other than support structure 12.

In this exemplary embodiment, sample drying unit 500 includes a support frame 510, a wringer unit 520, and a press unit 560. The support frame 510 is coupled to the support structure 12 of automated material testing system 10 and physically supports the components of sample drying unit 500 including, for example, wringer unit 520 and press unit 560. In this exemplary embodiment, the support frame 510 includes a pair of absorbent material holders 512 (shown as absorbent material holders 512-1 and 512-2 in FIGS. 24-27) and one or more pairs of absorbent material guides 514 (shown as a first pair of absorbent material guides 514-1 and a second pair of absorbent material guides 514-2 in FIGS. 24-27). Absorbent material holders 512 comprise elongate rods configured to receive a pair of rolls 501 and 503 of the absorbent material 502. In other embodiments, absorbent material holders 512 may vary in configuration from that shown in FIGS. 24-27. For instance, in some embodiments, absorbent material may not be rolled into or on rolls 501 and 503 and instead may be deployed and/or stored differently.

The pairs of absorbent material guides 514 are similarly elongate and configured to guide a sheet of the absorbent material 502 as the absorbent material 502 is transferred linearly (indicated by arrows 504 in FIG. 27) from a first roll 501 to an opposing second roll. In some embodiments, the first roll 501 may comprise a new or fresh roll of the absorbent material 502 while the second roll 503 may comprise a moistened roll having received moisture transferred from one or more sample containers 1 to the absorbent material 1. In some embodiments, the absorbent material 502 may comprise a towel such as a paper towel and/or other paper-based products. However, the configuration of absorbent material 502 may vary in other embodiments.

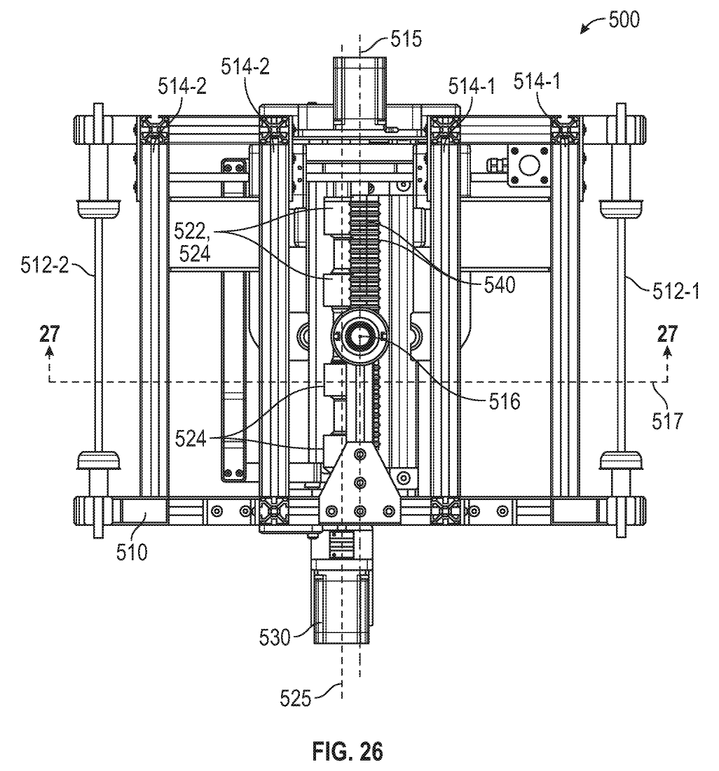

In this exemplary embodiment, support frame 510 additionally includes a sample platform 516 aligned with a longitudinal axis 515 (shown in FIG. 26) of the sample drying unit 500. Additionally, sample platform 516 is positioned between the pairs of absorbent material guides 514 along a lateral axis 517 (shown in FIG. 26) of the sample drying unit 500. As will be discussed further herein, sample containers 1 may be positioned atop the sample platform 516 to facilitate the transfer of moisture from the sample container 1 to the absorbent material 502 during the operation of sample drying unit 500.

The wringer unit 520 of sample drying unit 500 controls the motion or travel of absorbent material 502 along transport direction 504 between the pair of rolls 501 and 503. In this exemplary embodiment, wringer unit 520 is supported by the support frame 510 at a lower end thereof and generally includes a drive roller 522, a rotary drive actuator 530 (including, e.g., an electric motor), and a pair of guide rollers 540. Drive actuator 530 drives rotation of the drive roller 522 about a rotational axis 525 in either rotational direction. The rotational axis 525 may extend parallel with and may be offset from the longitudinal axis 515 of sample drying unit 500.

Drive actuator 530 is in signal communication with and operable by the system controller 600 as will be discussed further herein. In this exemplary embodiment, the drive roller 522 comprises a plurality of longitudinally spaced lobes 524 that frictionally contact the absorbent material 502 in response to operation of the drive actuator 530 to drive motion of the absorbent material 502 in the transport direction 504. The plurality of lobes 524 may comprise a relatively soft material having a relatively great coefficient of friction such as elastomeric materials and the like whereby the lobes 524 may continuously impart force to the absorbent material 502 without tearing or otherwise damaging the absorbent material 502. Guide rollers 540 rotate about central, rotational axes both extending parallel with the longitudinal axis 515 of sample drying unit 500. Guide rollers 540 are laterally and vertically spaced from each other such that a small gap 542 (shown in FIG. 27) is formed therebetween through which the absorbent material 502 passes as it is contacted and guided by the guide rollers 540. Additionally, in this exemplary embodiment, the pair of guide rollers 540 each comprise a plurality of alternating grooves and annular ridges such that, as the absorbent material passes through the gap 542, the guide rollers 540 may apply tension to the absorbent material 502 to prevent an excess of slack forming in the absorbent material 502 as is travels along transport direction 504 from the first roll 501 to the second roll 503. In other embodiments, the configuration of guide rollers 540 may vary form that shown in FIGS. 24-27.

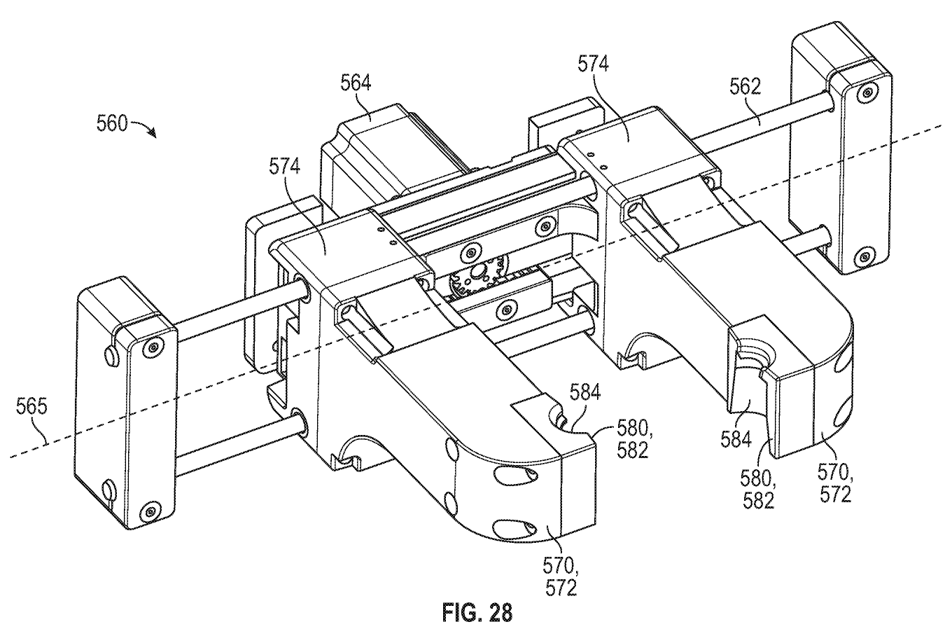

The press unit 560 of sample drying unit 500 is generally configured to press the absorbent material 502 circumferentially about the outer surface of a sample container 1 loaded onto the sample platform 516. Referring now to FIGS. 28-30, additional views of the press unit 560 are shown. In this exemplary embodiment, press unit 560 generally includes a linear jaw actuator 562 defining a linear, jaw axis 565, and a pair of jaws 570 transportable along the jaw axis 565 in response to the operation of jaw actuator 562. In this exemplary embodiment, jaw actuator 562 comprises an electric motor 564 and an output driven by the electric motor 564 such as a lead screw and the like that converts rotational motion of the electric motor 564 into linear travel of the jaws 570 along jaw axis 565. The electric motor 564 of jaw actuator 562 is in signal communication with and operable by the system controller 600 of automated material testing system 10.

Jaws 570 each extend between a first or proximal end 572 coupled to the jaw actuator 562 and an opposing second or distal end 574 spaced from the jaw actuator 562 in a direction that extends laterally relative to the jaw axis 565. In this exemplary embodiment, a jaw pad 580 is positioned along each jaw 570 at or proximal to the distal end 574 thereof. Jaw pads 580 each define an inner engagement surface 582 facing the engagement surface 582 of the opposing jaw pad 580. Jaws 570 are moveable along jaw axis 565 by jaw actuator 562 between first or open positions (shown in FIGS. 28-30) in which engagement surfaces 582 of jaw pads 580 are separated by a first distance along the jaw axis 565 and second or closed positions in which engagement surfaces 582 are separated by a second distance along the jaw axis 565 that is less than the first distance. In some embodiments, the second distance may be zero with engagement surfaces 582 of jaw pads 580 at least in partial direct contact with each other when jaws 570 are in the closed positions.

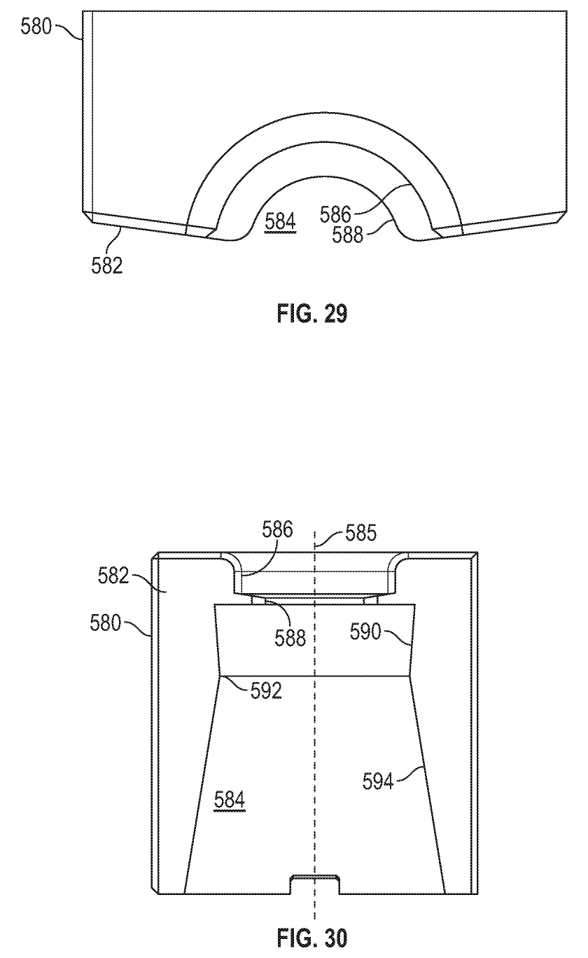

As shown particularly in FIGS. 29 and 30, a container receptacle 584 is formed along the engagement surface 582 of each jaw pad 580. A sample container 1 including the stopper 15 thereof is receivable in the container receptacle 584 along with the absorbent material 502 when the jaws 570 are in the closed positions to press the absorbent material 502 evenly and circumferentially against the outer surface of the sample container 1. Particularly, the absorbent material 502 is trapped between the engagement surfaces 582 of jaw pads 580 and the outer surface sample container 1 such that the portions of engagement surfaces 582 defining container receptacles 584 evenly and circumferentially presses the absorbent material 502 against the outer surface of the sample container 1 to transfer moisture from the outer surface of sample container 1 to the absorbent material 502. Once this moisture has been transferred to the absorbent material 502, jaws 570 may be returned to their open positions and the wringer unit 520 may be operated to transport the moistened absorbent material 502 along the transport direction 504 to thereby position dry absorbent material 502 about the sample container 1.

The shape of container receptacle 584 is configured to mirror the shape of the outer surface of the sample container 1 such that no gaps are formed (or at least the number or size thereof are minimized) between the absorbent material 502 (trapped between the engagement surface 582 defining container receptacle 584 and the outer surface of sample container 1) and the outer surface of the sample container 1. In this exemplary embodiment, container receptacle 584 extends along a longitudinal or central receptacle axis 585 and is defined by an upper annular surface 586 extending from a first or upper end of jaw pad 580, an annular reduced diameter section or shoulder 588 extending from a lower end of the upper annular surface 586 and radially towards the receptacle axis 585, a first frustoconical surface 590 extending from a lower end of the annular shoulder 588 towards an annular interface 592 spaced along receptacle axis 585 from the annular shoulder 588, and a second frustoconical surface 594 extending from the annular interface 592 to a second or lower end of the jaw pad 580.

In this exemplary embodiment, the ID of first frustoconical surface 590 decreases in magnitude moving along the receptacle axis 585 from an upper end thereof adjacent the lower end of annular shoulder 588 to an opposing lower end thereof at the annular interface 592. Conversely, in this exemplary embodiment, the ID of second frustoconical surface 594 increases moving along receptacle axis 585 from the annular interface 592 to the lower end of the jaw pad 580. In some embodiments, first frustoconical surface 590 of container receptacle 584 mirrors or is configured similarly as the first frustoconical surface 7 of container body 3 while second frustoconical surface 594 mirrors or is configured similarly as the second frustoconical surface 9 of container body 3. In some embodiments, the annular shoulder 588 of container receptacle 584 is inserted into the annular groove 20 formed in the stopper 15 of sample container 1 to permit absorbent material 502 extending over the annular shoulder 588 to contact the outer surface of stopper 15 defining annular groove 20 and thereby remove moisture therefrom. However, in other embodiments, the configuration of container receptacles 584 may vary from that shown in FIGS. 28-30. For instance, the configuration of container receptacles 584 may vary in applications in which the configuration of the sample container varies from that of the sample container 1 shown in FIG. 11.

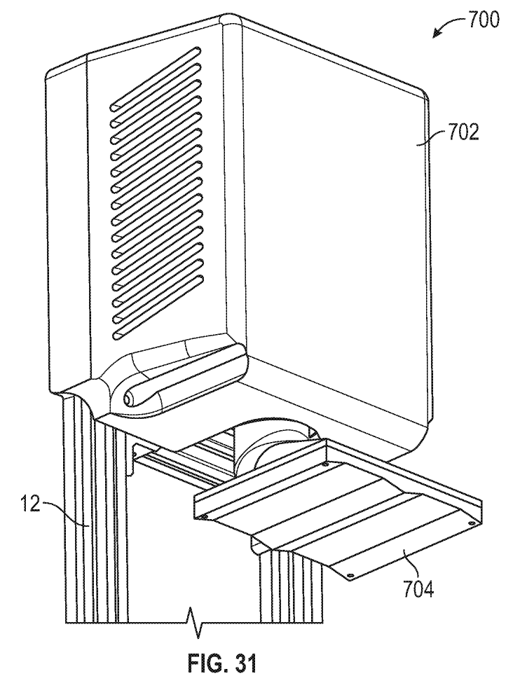

Referring to FIG. 31, in some embodiments, automated material testing system 10 additionally includes a gripper drying unit 700 configured to dry the gripper 60 of robotic arm 30 so that any moisture located thereon (e.g., from carrying a wet sample container 1) may be removed before contacting a dried sample container 1. In other embodiments, automated material testing system 10 may not include a separate gripper drying unit 700 such as the gripper drying unit 700 shown in FIG. 31. In some embodiments, gripper drying unit 700 is physically supported by the support structure 12 of automated material testing system 10 such that the position of gripper drying unit 700 in physical space (e.g., relative to base 32 of robotic arm 30) may be encoded into instructions stored in the system controller 600. In other embodiments, gripper drying unit 700 may be separately supported by a support structure other than support structure 12.

In this exemplary embodiment, gripper drying unit 700 comprises an air dryer including an air blower 702, and one or more pads 704 in which a plurality of openings are formed from which a drying fluid (e.g., air) is ejected towards the gripper 60 when the gripper 60 is positioned beneath the drying pad 704. The air blower 702 is in signal communication with and operable by the system controller 600 of automated material testing system 10. In some embodiments, air blower 702 includes a heating element (e.g., an electrical heating element) for heating the air blown by the air blower 702 of gripper drying unit 700. In this manner, the air blown by the air blower 702 may dry the gripper 60 such as by displacing and/or evaporating fluid positioned thereon. In other embodiments, the configuration of gripper drying unit 700 may vary; for instance, in other embodiments, gripper drying unit 700 may utilize an absorbent material that is brought into contact with the gripper 60 to dry the gripper 60 of robotic arm 30.

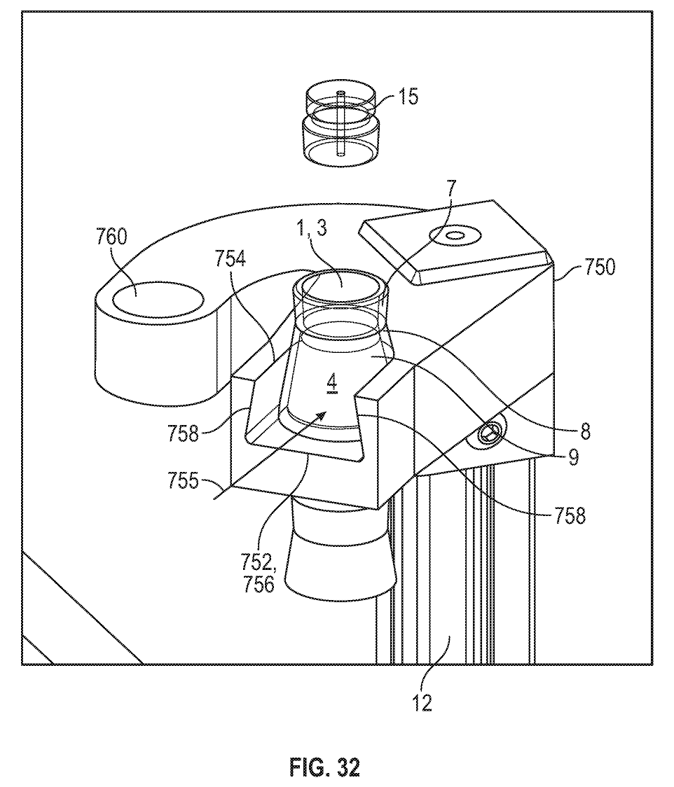

Referring to FIG. 32, in some embodiments, automated material testing system 10 includes a sample stand or holder 750 to assist the gripper 60 of robotic arm 30 in removing the stopper 15 from the container body 3 of sample container 1 as needed during the operation of automated material testing system 10, as will be discussed further herein. In other embodiments, automated material testing system 10 may not include a separate sample holder such as the sample holder 750 shown in FIG. 32. In some embodiments, sample holder 750 is physically supported by the support structure 12 of automated material testing system 10 such that the position of sample holder 750 in physical space (e.g., relative to base 32 of robotic arm 30) may be encoded into instructions stored in the system controller 600. In other embodiments, sample holder 750 may be separately supported by a support structure other than support structure 12.

In this exemplary embodiment, sample holder 750 comprises or defines a first or body receptacle 752 and a second or stopper receptacle 760 that is separate from the body receptacle 752. Body receptacle 752 is configured to receive and capture the container body 3 of sample container 1while the stopper receptacle 760 is configured to receive the stopper 15 of sample container 1. Particularly, body receptacle 752 is configured to capture the container body 3 whereby the container body 3 will remain locked to the sample holder 750 even when a vertically upwards directed force is applied to the container body 3.

In this exemplary embodiment, body receptacle 752 comprises a first or vertically upper end 754 and an opposing second or vertically lower end 756. Additionally, body receptacle 752 is defined by a pair of opposing inclined surfaces 758 extending between ends 752 and 754. A width of body receptacle 752 declines gradually moving from the lower end 756 to the upper end thereof such that body receptacle 752 forms a slot in which the sample container 1 is insertable in a horizontal direction (indicated by arrow 755 in FIG. 32) but not vertically due to the width of the upper end 754 of body receptacle 752 being less than the diameter of the lower end 6 of container body 3. Thus, upon being inserted into the body receptacle 752, the container body 3 is prevented from being vertically lifted outwardly from the body receptacle 752 due to interference between inclined surfaces 758 and the second frustoconical surface 9 of container body 3. The interlocking between body receptacle 752 and container body 3 permits the gripper 60 of robotic arm 30 to release the stopper 15 from the container body 3 which may be friction fit therein such that the gripper 60 may need to apply a vertically directed force to the stopper 15 to release it from the upper end 5 of the container body 3.

In this exemplary embodiment, the stopper receptacle 760 is generally cylindrical and is configured to receive the lower end 18 of stopper 15. In other embodiments, the configuration of stopper receptacle 760 may vary. For instance, in other embodiments, stopper receptacle 760 may instead include a planar surface upon which the stopper 15 may be positioned. Once stopper 15 has been received in stopper receptacle 760, the container body 3 sans stopper 15 may be removed horizontally from body receptacle 752 for further use during the operation of automated material testing system 10.

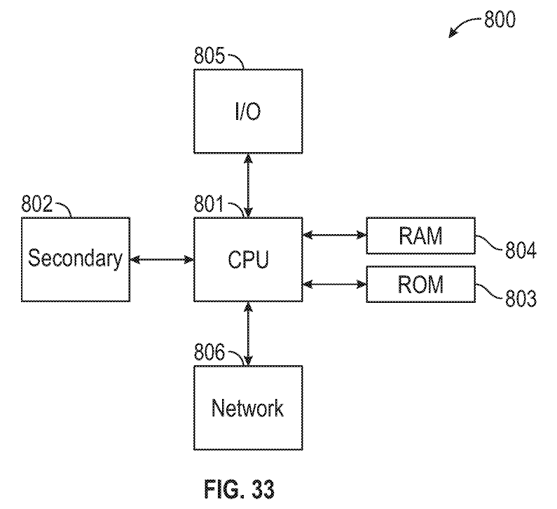

Any of the systems and methods disclosed herein can be carried out (e.g., entirely or partially) on a computer or other device comprising a processor (e.g., a desktop computer, a laptop computer, a tablet, a server, a smartphone, or some combination thereof). Referring now to FIG. 33, a computer system 800 suitable for implementing one or more embodiments disclosed herein (e.g., system controller 600 shown in FIGS. 1-4) is shown. The computer system 800 includes a processor 801 (which may be referred to as a central processor unit or CPU) that is in communication with memory devices including secondary storage 802, read only memory (ROM) 803, random access memory (RAM) 804, input/output (I/O) devices 805, and network connectivity devices 806. The processor 801 may be implemented as one or more CPU chips.

It is understood that by programming and/or loading executable instructions onto the computer system 800, at least one of the CPUs 801, the RAM 804, and the ROM 803 are changed, transforming the computer system 800 in part into a particular machine or apparatus having the novel functionality taught by the present disclosure. Thus, the RAM 804 and/or the ROM 803 may comprise a non-transitory machine-readable (or computer-readable) medium that may include instructions (which may be referred to herein as machine-readable instructions) that are executable by CPU 801 to provide functionality to computer system 800. Thus, in some embodiments, a machine-readable instructions stored on a memory may be executed on a processor, so as to configured the processor to carry out some or all of the features of the methods described herein.

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware (for example in an application specific integrated circuit (ASIC),or field-programmable gate arrays (FPGA)) because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the computer system 800 is turned on or booted, the CPU 801 may execute a computer program or application. For example, the CPU 801 may execute software or firmware stored in the ROM 803 or stored in the RAM 804. In some cases, on boot and/or when the application is initiated, the CPU 801 may copy the application or portions of the application from the secondary storage 802 to the RAM 804 or to memory space within the CPU 801 itself, and the CPU 801 may then execute instructions of which the application is comprised. In some cases, the CPU 801 may copy the application or portions of the application from memory accessed via the network connectivity devices 806 or via the I/O devices 805 to the RAM 804 or to memory space within the CPU 801, and the CPU 801 may then execute instructions of which the application is comprised. During execution, an application may load instructions into the CPU 801, for example load some of the instructions of the application into a cache of the CPU 801. In some contexts, an application that is executed may be said to configure the CPU 801 to do something, e.g., to configure the CPU 801 to perform the function or functions promoted by the subject application. When the CPU 801 is configured in this way by the application, the CPU 801 becomes a specific purpose computer or a specific purpose machine.

The secondary storage 802 is typically comprised of one or more disk drives or tape drives and is used for non-volatile storage of data and as an over-flow data storage device if RAM 804 is not large enough to hold all working data. Secondary storage 802 may be used to store programs which are loaded into RAM 804 when such programs are selected for execution. The ROM 803 is used to store instructions and perhaps data which are read during program execution. ROM 803 is a non-volatile memory device which typically has a small memory capacity relative to the larger memory capacity of secondary storage 802. The RAM 804 is used to store volatile data and perhaps to store instructions. Access to both ROM 803 and RAM 804 is typically faster than to secondary storage 802. The secondary storage 802, the RAM 804, and/or the ROM 803 may be referred to in some contexts as computer readable storage media and/or non-transitory computer readable media.

I/O devices 805 may include printers, video monitors, electronic displays (e.g., liquid crystal displays (LCDs), plasma displays, organic light emitting diode displays (OLED), touch sensitive displays, etc.), keyboards, keypads, switches, dials, mice, track balls, voice recognizers, card readers, paper tape readers, or other well-known input devices.

The network connectivity devices 806 may take the form of modems, modem banks, Ethernet cards, Omni-Path Architecture (OPA), InfiniBand (IB), universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 806 may enable the processor 801 to communicate with the Internet or one or more intranets. With such a network connection, it is contemplated that the processor 801 might receive information from the network, or might output information to the network (e.g., to an event database) in the course of performing the methods described herein. Such information, which is often represented as a sequence of instructions to be executed using processor 801, may be received from and outputted to the network, for example, in the form of a computer data signal embodied in a carrier wave.

Such information, which may include data or instructions to be executed using processor 801 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several known methods. The baseband signal and/or signal embedded in the carrier wave may be referred to in some contexts as a transitory signal.

The processor 801 executes instructions, codes, computer programs, scripts which it accesses from hard disk, floppy disk, optical disk, solid state drives (SSD) (these various disk-based systems may all be considered secondary storage 802), flash drive, ROM 803, RAM 804, or the network connectivity devices 806. While only one processor 801 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 802, for example, hard drives, floppy disks, optical disks, and/or other device, the ROM 803, and/or the RAM 804 may be referred to in some contexts as non-transitory instructions and/or non-transitory information.

In an embodiment, the computer system 800 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 800 to provide the functionality of a number of servers that is not directly bound to the number of computers in the computer system 800. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 800, at least portions of the contents of the computer program product to the secondary storage 802, to the ROM 803, to the RAM 804, and/or to other non-volatile memory and volatile memory of the computer system 800. The processor 801 may process the executable instructions and/or data structures in part by directly accessing the computer program product, for example by reading from a CD-ROM disk inserted into a disk drive peripheral of the computer system 800. Alternatively, the processor 801 may process the executable instructions and/or data structures by remotely accessing the computer program product, for example by downloading the executable instructions and/or data structures from a remote server through the network connectivity devices 806. The computer program product may comprise instructions that promote the loading and/or copying of data, data structures, files, and/or executable instructions to the secondary storage 802, to the ROM 803, to the RAM 804, and/or to other non-volatile memory and volatile memory of the computer system 800.

In some contexts, the secondary storage 802, the ROM 803, and the RAM 804 may be referred to as a non-transitory computer readable medium or a computer readable storage media. A dynamic RAM embodiment of the RAM 804, likewise, may be referred to as a non-transitory computer readable medium in that while the dynamic RAM receives electrical power and is operated in accordance with its design, for example during a period of time during which the computer system 800 is turned on and operational, the dynamic RAM stores information that is written to it. Similarly, the processor 801 may comprise an internal RAM, an internal ROM, a cache memory, and/or other internal non-transitory storage blocks, sections, or components that may be referred to in some contexts as non-transitory computer readable media or computer readable storage media.

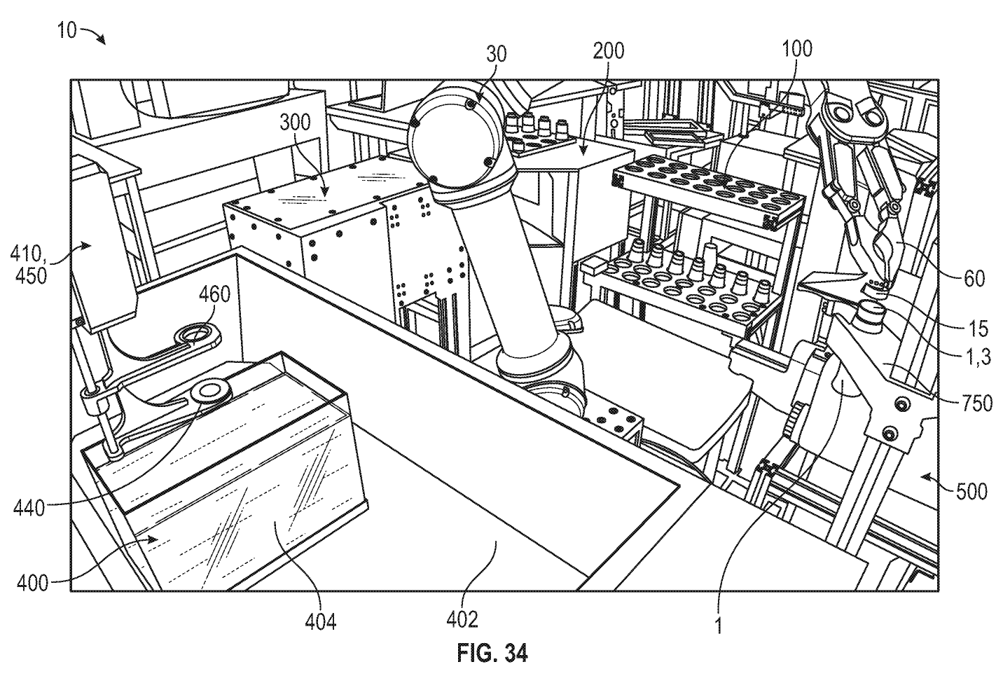

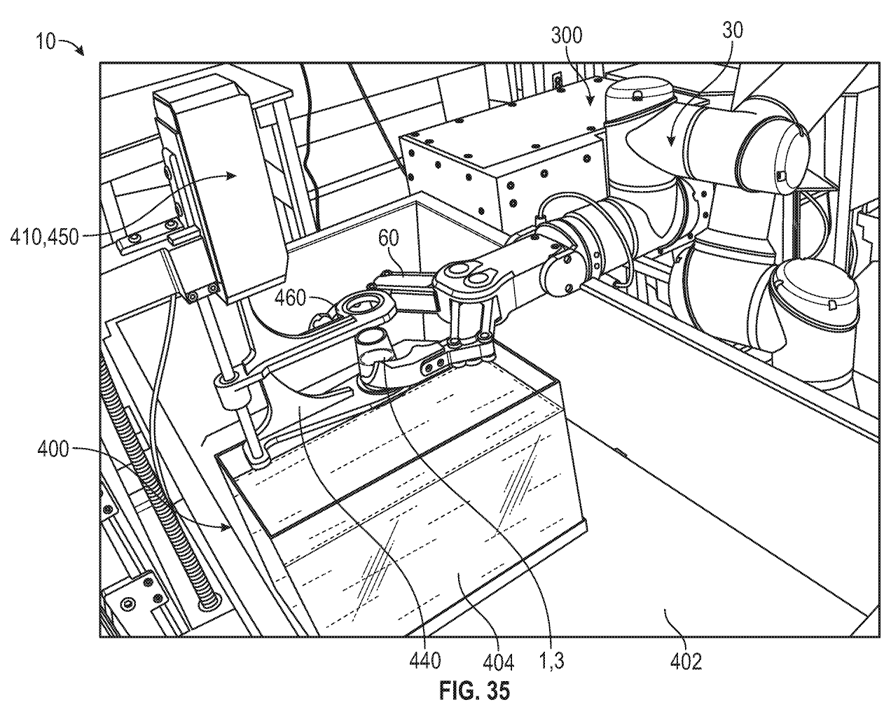

Referring to FIGS. 1-4 and 34-38, additional illustrations of automated material system 10 are shown. Particularly, FIGS. 34-38 illustrate an exemplary implementation of automated material system 10 testing or determining the specific gravity of a sample (e.g., a semi-solid asphalt binder) contained in a selected sample container 1. In this example, the robotic arm 30 may initially acquire a sample container 1 from the sample storage unit 100 and delivering the sample container 1 to the sample identification unit 200. The sample container 1 contains sample material 4 but is not filled with a reference fluid (e.g., water) such that the sample container 1 occupies a dry state. As used herein, the term “dry state” is defined as a state of a sample container containing a sample material but not a reference fluid such as, for example, water. The sample identification unit 200 may then identify the selected sample container 1 and the robotic arm 30 may retrieve the sample container 1 from the sample identification unit 200 and delivering said sample container 1 to the sample scale unit 300.

Subsequently, the sample container 1 may be weighed (e.g., containing only the sample material and not an additional volume of reference fluid such as water) by the sample scale unit 300 to thereby measure a first or dry weight of the sample container 1. Following weighing, as shown particularly in FIG. 34, the gripper 60 of robotic arm 30 may remove the stopper 15 from the container body 3 of sample container 1. In some embodiments, robotic arm 30 may initially position sample container 1 in the body receptacle 752 of sample holder 750 and remove the stopper 15 from the container body 3 thereof. The gripper 60 may position the stopper 15 in the stopper receptacle 760 and then retrieve the container body 3 without the stopper 15 from the body receptacle 752.

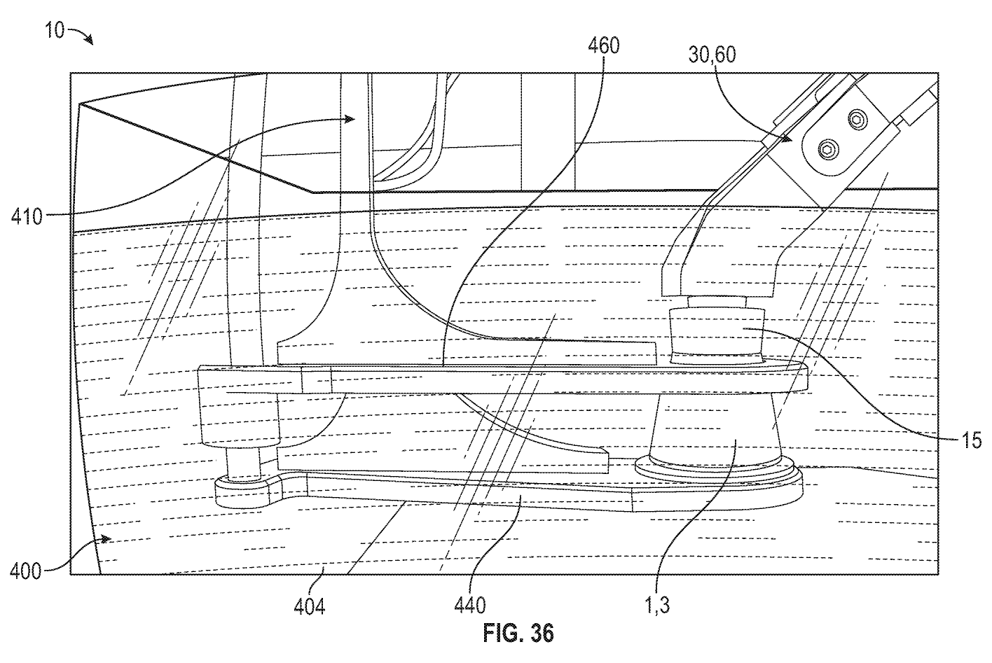

FIGS. 34 and 35 illustrate an exemplary operation of the sample conditioning unit 400 once the gripper 60 of robotic arm 30 delivers the sample container 1 thereto. Particularly, the sample conditioning unit 400 may submerge the sample container 1 into the reference fluid bath 404 to fill the sample container 1 with reference fluid (e.g., water) therefrom to transition the sample container 1 from the dry state to a wet state. As used herein, the term “wet state” is defined as a state of a sample container in which the sample container contains both a sample material and a reference fluid such as, for example, water. Additionally, the gripper 60 of robotic arm 30 returns the stopper 15 to the sample container 1 while still submerged in the reference fluid bath 404 as shown in FIG. 36.

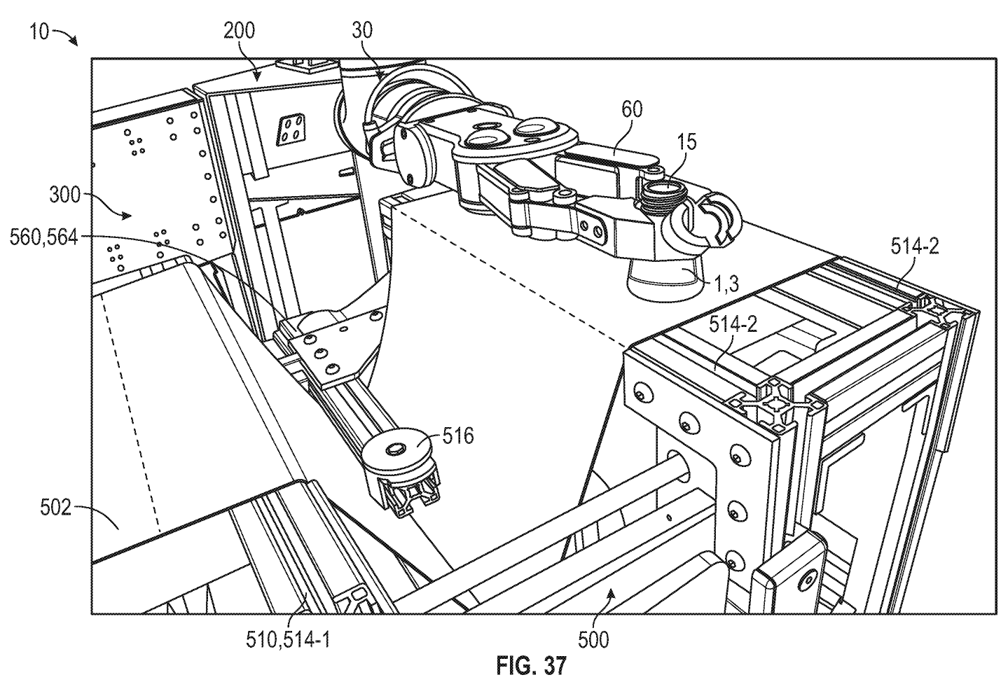

After the sample container 1 and sample material contained thereby have been brought to a desired temperature via the reference fluid bath 404, the gripper 60 of robotic arm 30 retrieves the sample container 1 (now including the stopper 15) to the sample drying unit 500 as shown in FIG. 37. Initially, a lower end of the container body 3 may be pressed by gripper 60 once or repeatedly against the portion of absorbent material 502 spanning between one or both of the pairs of absorbent material guides 514. Additionally, the gripper drying unit 700 may be activated to dry the gripper 60 of robotic arm 30.

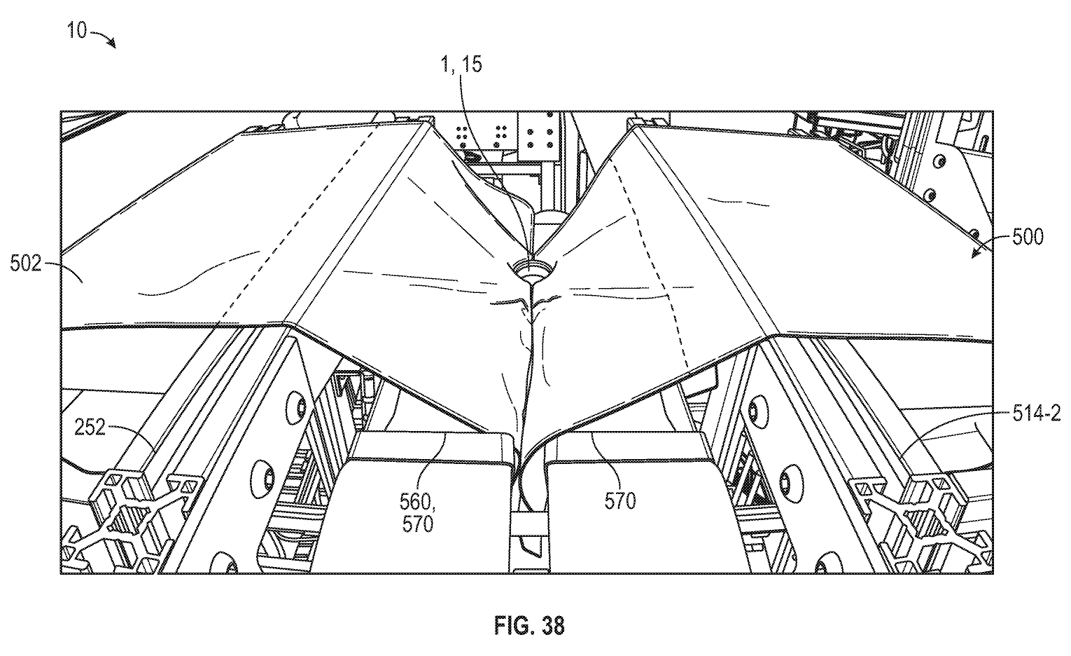

As shown particularly in FIG. 38, following drying of the bottom of container body 3, sample container 1 may be placed by gripper 60 onto the platform 516 of sample drying unit 500 and jaw actuator 562 of press unit 560 may be operated to shift jaws 570 from their open positions to their closed positions. In their closed positions, enclose around the sample container 1 to press the absorbent material 502 against the outer surface of the sample container 1. The jaws 570 may then be returned to their open positions and gripper 60 may rotate the sample container by a predefined angle (e.g., 45 degrees) before repositioning the sample container 1 on the platform 516. Drive roller 522 of the wringer unit 520 may be activated to transport the absorbent material 502 along the transport direction 504 such that dry absorbent material 502 is positioned between the pair of jaws 570. Jaws 570 may again be closed to dry the remainder of the outer surface of the sample container 1 such that no remaining moisture remains thereon.

Following drying of the sample container 1 by the sample drying unit 500, the gripper 60 of robotic arm 30 may return the sample container 1 filled with reference fluid (e.g., water) to the sample scale unit 300 for weighing now that it has been externally dried and internally filled with reference fluid. Particularly, the sample scale unit 300 may measure a second or wet weight of the sample container 1 with sample container 1 in the wet state. Following weighing, the gripper 60 of robotic arm 30 may return the sample container 1 to the sample storage unit 100 at the completion of the automated testing of the sample container 1. In at least some embodiments, each of these operations may be automated and controlled by the system controller 600 of automated material testing system 10 in accordance with a predefined routine stored in a memory device thereof. Additionally, the system controller 600 may determine the specific gravity of the sample material 4 contained in the sample container 1 using the dry weight and the wet weight of the sample container obtained by the sample scale unit 300. The specific gravity of sample material 4 may also be based on a known weight of the specific (empty) sample container 1 used to carry the sample material 4 stored in a memory device of the system controller 600. Along with robotic arm 30, each of the different operable components of automated material testing system 10 (e.g., robotic arm 30 and units 200, 300, 400, 500, and 700) may also be automated in accordance with instructions contained in the memory device of the computer system such that a human operator may not be required to intervene during the course of the operation of the automated material testing system 10.

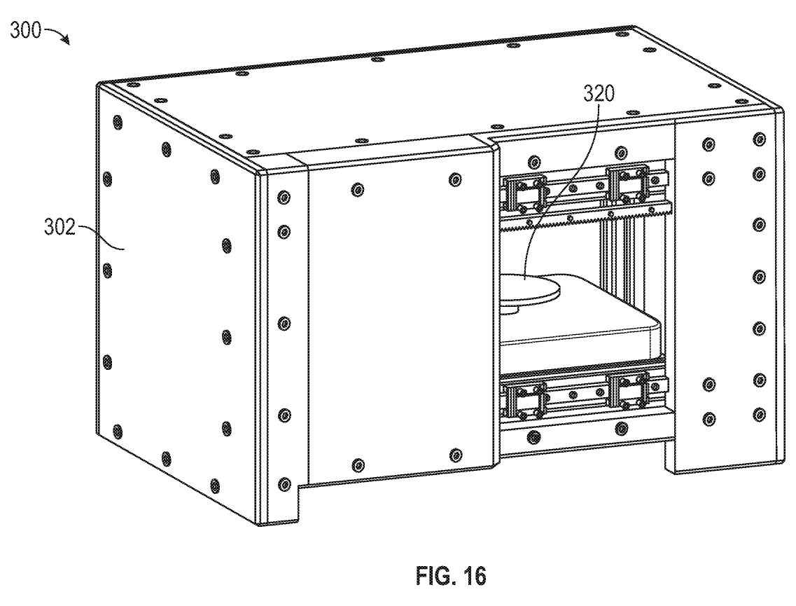

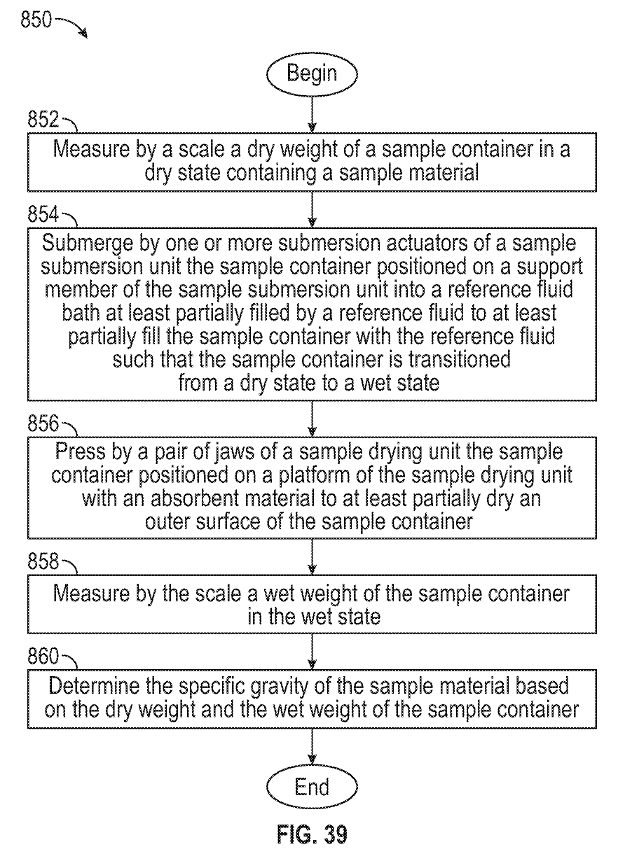

Referring to FIG. 39, an embodiment of a method for determining the specific gravity of a sample material (e.g., sample material 4 shown in FIG. 11) is shown. Initially, at block 852, method 850 includes measuring by a scale (e.g., scale 320 shown in FIG. 16) a dry weight of a sample container (e.g., sample container 1 shown in FIG. 11) in a dry state containing a sample material.

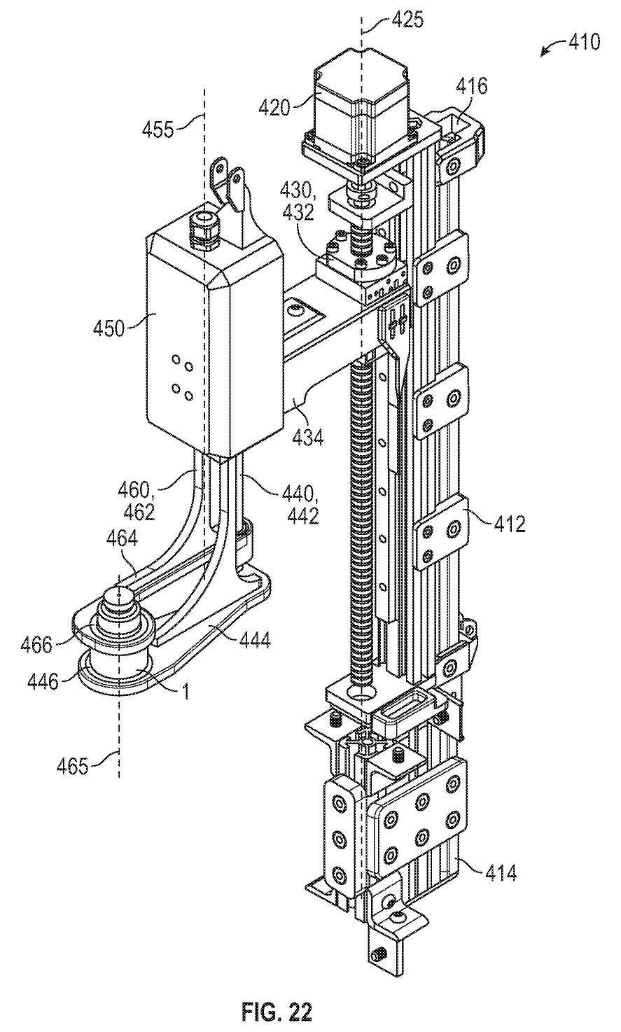

At block 854, method 850 includes submerging by one or more submersion actuators (e.g., submersion actuators 420 and 450 shown in FIG. 22) of a sample submersion unit (e.g., sample submersion unit 410 shown in FIG. 22) the sample container positioned on a support member (e.g., lower support arm 440 shown in FIG. 22) of the sample submersion unit into a reference fluid bath (e.g., reference fluid baths 404 shown in FIG. 18) at least partially filled by a reference fluid to at least partially fill the sample container with the reference fluid such that the sample container is transitioned from a dry state to a wet state.

At block 856, method 850 includes pressing by a pair of jaws (e.g., the pair of jaws 570 shown in FIG. 28) of a sample drying unit (e.g., sample drying unit 500 shown in FIG. 24) the sample container positioned on a platform of the sample drying unit with an absorbent material (e.g., absorbent material 502 shown in FIG. 27) to at least partially dry an outer surface of the sample container. At block 858, method 850 includes measuring by the scale a wet weight of the sample container in the wet state. At block 860, method 850 includes determining the specific gravity of the sample material based on the dry weight and the wet weight of the sample container.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. An automated material testing system for measuring the specific gravity of a sample material, the system comprising:
a sample scale unit comprising a scale configured to measure a weight of a sample container and a sample material received in the sample container;
a sample conditioning unit comprising a reference fluid bath at least partially filled with a reference fluid and a sample submersion unit comprising a support member configured to receive the sample container and one or more submersion actuators configured to submerge the sample container into the reference fluid bath when the sample container is received by the support member to at least partially fill the sample container with the reference fluid; and
a sample drying unit comprising an absorbent material, a platform configured to receive the sample container, and a press unit comprising a pair of jaws and one or more jaw actuators configured to enclose the pair of jaws around the sample container when the sample container is positioned on the platform to press the absorbent material against an outer surface of the sample container.

2. The system of claim 1, further comprising:
a robotic arm comprising a base, a gripper opposite the base, and a plurality of joints located between the base and the gripper configured to provide the gripper with a plurality of degrees of freedom.

3. The system of claim 2, wherein the gripper comprises gripper pad having an engagement surface that defines a first receptacle configured to grip a first object and a second receptacle, separate from the first receptacle, configured to grip a second object having a different shape than the first object.

4. The system of claim 3, wherein the first object comprises a container body of the sample container and the second object comprises a lid of the sample container.

5. The system of claim 3, wherein the first receptacle extends along a first receptacle axis and the second receptacle extends along a second axis that extends at a non-zero angle relative to the first receptacle axis.

6. The system of claim 1, further comprising:
a sample identification unit comprising a sensor configured to read an identifier located on the sample container.

7. The system of claim 6, wherein the sensor comprises a camera and the identifier comprises a visually identifiable label.

8. The system of claim 1, wherein the pair of jaws of the sample drying unit comprises a pair of jaw pads each defining a sample receptacle configured to receive at least a portion of the sample container when the pair of jaws are in a closed position.

9. The system of claim 1, wherein the sample drying unit comprises a drive roller configured to drive linear motion of the absorbent material along a transport direction.

10. The system of claim 1, wherein the sample submersion unit comprises a plurality of the support members including a lower support member and an upper support member both configured to retain the sample container to the sample submersion unit.

11. The system of claim 10, wherein the one or more submersion actuators comprises a first submersion actuator, and wherein the sample submersion unit comprises a platform coupled between the lower support member and the first submersion actuator such that the first submersion actuator is configured to displace the lower support member along a first submersion axis.

12. The system of claim 11, wherein the one or more submersion actuators comprises a second submersion actuator coupled between the platform and the upper support member such that the second submersion actuator is configured to displace the upper support member along a second submersion axis relative to the lower support member.

13. A method for determining the specific gravity of a sample material, the method comprising:
(a) measuring by a scale a dry weight of a sample container in a dry state containing a sample material;
(b) submerging by one or more submersion actuators of a sample submersion unit the sample container positioned on a support member of the sample submersion unit into a reference fluid bath at least partially filled by a reference fluid to at least partially fill the sample container with the reference fluid such that the sample container is transitioned from a dry state to a wet state;
(c) pressing by a pair of jaws of a sample drying unit the sample container positioned on a platform of the sample drying unit with an absorbent material to at least partially dry an outer surface of the sample container;
(d) measuring by the scale a wet weight of the sample container in the wet state; and
(e) determining the specific gravity of the sample material based on the dry weight and the wet weight of the sample container.

14. The method of claim 13, further comprising:
(f) positioning by a gripper of a robotic arm a sample container containing a sample material on a scale of a sample scale unit;
(g) positioning by the gripper the sample container on the support member of a sample submersion unit; and
(h) positioning by the gripper the sample container on the platform of a sample drying unit.

15. The method of claim 13, further comprising:
(f) removing by a gripper of a robotic arm a lid of the sample container from a container body of the sample container.

16. The method of claim 13, further comprising:
(f) linearly transporting the absorbent material along a transport direction following (c).

17. The method of claim 13, further comprising:
(f) capturing the sample container between the support member of the sample submersion unit, the support member comprising a lower support member of the sample submersion unit, and an upper support member of the sample submersion unit to lock the sample container to the sample submersion unit.

18. The method of claim 13, further comprising:
(f) coupling by a gripper of a robotic arm a lid of the sample container to a container body of the sample container with the sample container submerged in the reference fluid bath.

19. The method of claim 13, further comprising:
(f) reading by a sensor an identifier located on the sample container to determine an identity of the sample container.

20. A non-transitory computer-readable medium comprising instructions, that when executed by a processor, perform the steps of:
measure using a scale a dry weight of a sample container in a dry state containing a sample material;
submerge using one or more submersion actuators of a sample submersion unit the sample container positioned on a support member of the sample submersion unit into a reference fluid bath at least partially filled by a reference fluid to at least partially fill the sample container with the reference fluid such that the sample container is transitioned from a dry state to a wet state;
press using a pair of jaws of a sample drying unit the sample container positioned on a platform of the sample drying unit with an absorbent material to at least partially dry an outer surface of the sample container;
measure using the scale a wet weight of the sample container in the wet state; and
determine the specific gravity of the sample material based on the dry weight and the wet weight of the sample container.
